(19) United States
(12) Patent Application Publication
(10) Pub. No.: US 2020/0393976 A1
(43) Pub. Date: Dec. 17, 2020

(54) SEMICONDUCTOR STORAGE DEVICE AND ELECTRONIC APPARATUS

(71) Applicant: SONY SEMICONDUCTOR SOLUTIONS CORPORATION, KANAGAWA (JP)

(72) Inventor: MASAHIRO SATO, TOKYO (JP)

(21) Appl. No.: 16/970,463

(22) PCT Filed: Feb. 8, 2019
(86) PCT No.: PCT/JP2019/004646

§ 371 Date: Aug. 17, 2020

(30) Foreign Application Priority Data
Feb. 26, 2018 (JP) 2018-031713

(51) Int. Cl. G06F 3/06

(52) U.S. Cl. CPC G06F 3/0619; G06F 3/0683; G06F 3/0653

(57) ABSTRACT

To be capable of detecting, in a more preferable manner, rewriting of information held in a storage element due to influence of an external factor. A semiconductor storage device including a plurality of storage elements each of which transitions to any of a plurality of states in accordance with an applied voltage, a control unit that assigns, as one bit, at least two or more storage elements included in the plurality of storage elements and controls, for each bit, application of a voltage to each of the two or more storage elements corresponding to the bit, and a determination unit that determines that the bit is normal in a case where a state of a part of the two or more storage elements assigned as the bit is different from a state of another storage element, and determines that the bit is abnormal in a case where respective states of the two or more storage elements are same.

### TECHNICAL FIELD

The present disclosure relates to a semiconductor storage device and an electronic apparatus.

### BACKGROUND ART

As a rewritable nonvolatile memory, for example, a magnetoresistive memory (magnetic random access memory: MRAM) adopting a magnetoresistive effect element as a storage element is known. In the MRAM, data is stored in accordance with a magnetization direction of a magnetic substance constituting the magnetoresistive effect element.

A magnetic tunnel junction (magnetic tunnel junction: MTJ) element is an example of the magnetoresistive effect element constituting the MRAM. The MTJ element is configured by laminating two ferromagnetic layers with a tunnel insulating film interposed therebetween, and uses a characteristic that a tunnel current flowing between the magnetic layers via the tunnel insulating film changes in accordance with a relationship of magnetization directions of the two ferromagnetic layers (in other words, a characteristic that the resistance of magnetic tunnel junction changes). Specifically, the MTJ element has a low element resistance in a case where the magnetization directions of the two ferromagnetic layers are parallel, and a high element resistance in a case where the magnetization directions of the two ferromagnetic layers are antiparallel. By associating each of such two states different from each other with data “0” or “1”, it is possible to use the MTJ element as a storage element. For example, Patent Document 1 discloses an example of a storage device (memory circuit) that can use the MTJ element as a storage element.

### CITATION LIST

### Patent Document

Patent Document 1: Japanese Patent Application Laid-Open No. 2013-171593

### SUMMARY OF THE INVENTION

### Problems to be Solved by the Invention

Meanwhile, it can be assumed that, in a storage device such as an MRAM, information held in a storage element is unintentionally or illegally rewritten due to influence of an external factor such as a strong magnetic field from the outside. In particular, some electronic apparatuses using storage devices such as MRAMs require higher security levels, such as an apparatus used for authentication or the like. In such an apparatus, it is required to introduce a technology capable of detecting rewriting of information held in a storage device even in a case where the information has been illegally rewritten.

Therefore, the present disclosure proposes a technology capable of detecting, in a more preferable manner, rewriting of information held in a storage element due to influence of an external factor.

### Solutions to Problems

According to the present disclosure, there is provided a semiconductor storage device including a plurality of storage elements each of which transitions to any of a plurality of states in accordance with an applied voltage, a control unit that assigns, as one bit, at least two or more storage elements included in the plurality of storage elements and controls, for each bit, application of a voltage to each of the two or more storage elements corresponding to the bit, and a determination unit that determines that the bit is normal in a case where a state of a part of the two or more storage elements assigned as the bit is different from a state of another storage element, and determines that the bit is abnormal in a case where respective states of the two or more storage elements are same.

Furthermore, according to the present disclosure, there is provided an electronic apparatus including a semiconductor storage device, in which the semiconductor storage device includes a plurality of storage elements each of which transitions to any of a plurality of states in accordance with an applied voltage, a control unit that assigns, as one bit, at least two or more storage elements included in the plurality of storage elements and controls, for each bit, application of a voltage to each of the two or more storage elements corresponding to the bit, and a determination unit that determines that the bit is normal in a case where a state of a part of the two or more storage elements assigned as the bit is different from a state of another storage element, and determines that the bit is abnormal in a case where respective states of the two or more storage elements are same.

### Effects of the Invention

As described above, according to the present disclosure, there is provided a technology capable of detecting, in a more preferable manner, rewriting of information held in a storage element due to influence of an external factor.

Note that the above effect is not necessarily limited, and any of the effects shown in the present specification or other effects that can be grasped from the present specification may be exhibited together with or in place of the above effect.

### BRIEF DESCRIPTION OF DRAWINGS

FIG. 1 is a block diagram illustrating an example of a schematic functional configuration of a semiconductor storage device according to an embodiment of the present disclosure.

FIG. 2 is an explanatory diagram for describing an outline of an MTJ element.

FIG. 3 is an explanatory diagram for describing an example of a schematic configuration of a semiconductor storage device according to a first comparative example.

FIG. 4 is a schematic circuit diagram illustrating an example of a configuration of the semiconductor storage device according to the first comparative example.

FIG. 5 is an explanatory diagram for describing an example of a schematic configuration of a memory cell in a semiconductor storage device according to a second comparative example.

FIG. 6 is a schematic circuit diagram illustrating an example of a configuration of the semiconductor storage device according to the second comparative example.

FIG. 7 is an explanatory diagram for describing an example of a schematic configuration of the semiconductor storage device according to the second comparative example.

FIG. 8 is an explanatory diagram for describing an example of control of the semiconductor storage device according to the second comparative example.

FIG. 9 is an explanatory diagram for describing an example of the control of the semiconductor storage device according to the second comparative example.

FIG. 10 is an explanatory diagram for describing an example of the control of the semiconductor storage device according to the second comparative example.

FIG. 11 is an explanatory diagram for describing an example of a schematic configuration of the semiconductor storage device according to the same embodiment.

FIG. 12 is an explanatory diagram for describing an example of control of the semiconductor storage device according to the same embodiment.

FIG. 13 is an explanatory diagram for describing an example of the control of the semiconductor storage device according to the same embodiment.

FIG. 14 is an explanatory diagram for describing an example of the control of the semiconductor storage device according to the same embodiment.

FIG. 15 is an explanatory diagram for describing an example of a mechanism for detecting that data has been rewritten due to an external factor in the semiconductor storage device according to the same embodiment.

FIG. 16 is an explanatory diagram for describing an example of the mechanism for detecting that data has been rewritten due to an external factor in the semiconductor storage device according to the same embodiment.

FIG. 17 is an explanatory diagram for describing an example of control in a case where it is detected that data has been rewritten due to an external factor in the semiconductor storage device according to the same embodiment.

FIG. 18 is an explanatory diagram for describing an example of a schematic configuration of a semiconductor storage device according to a modification.

FIG. 19 is an explanatory diagram for describing an example of control of the semiconductor storage device according to the modification.

FIG. 20 is an explanatory diagram for describing an example of the control of the semiconductor storage device according to the modification.

FIG. 21 is an explanatory diagram for describing an example of the control of the semiconductor storage device according to the modification.

FIG. 22 is an explanatory diagram for describing an application example of the semiconductor storage device according to the embodiment of the present disclosure.

### MODE FOR CARRYING OUT THE INVENTION

Hereinafter, a preferred embodiment of the present disclosure will be described in detail with reference to the accompanying drawings. Note that, in the present specification and the drawings, components having substantially the same functional configuration are denoted by the same reference numerals, and thus redundant description will be omitted.

Note that the description will be made in the following order.

1. Schematic Configuration

2. Outline of Magnetic Tunnel Junction Element

3. Comparative Example

3.1. First Comparative Example

3.2. Second Comparative Example

4. Technical Issues

5. Technical Characteristics

5.1. Configuration

5.2. Control

5.3. Data Abnormality Detection

5.4. Modification

5.5. Supplement

6. Application Example

7. Conclusion

### 1. SCHEMATIC CONFIGURATION

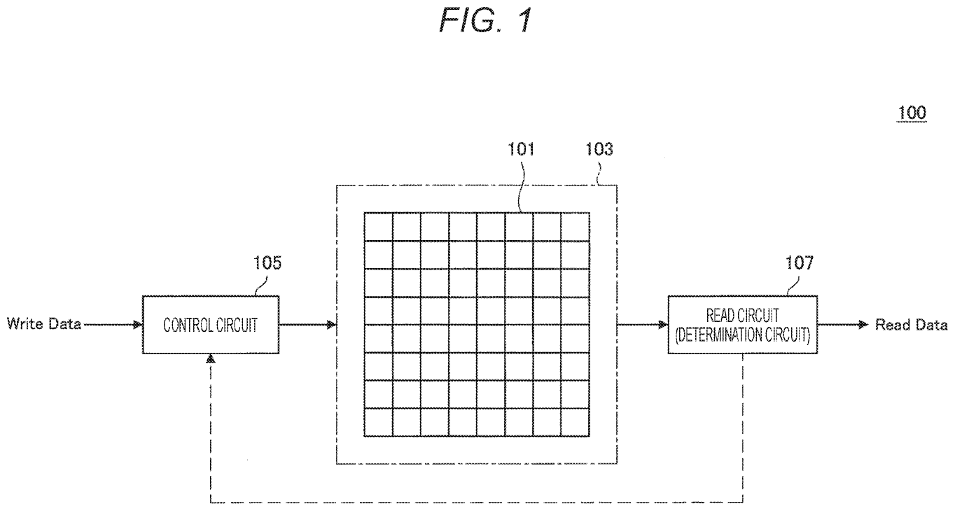

First, an example of a schematic functional configuration of a semiconductor storage device according to an embodiment of the present disclosure will be described with reference to FIG. 1. FIG. 1 is a block diagram illustrating the example of the schematic functional configuration of the semiconductor storage device according to the present embodiment.

As illustrated in FIG. 1, a semiconductor storage device 100 according to the present embodiment includes an element array 103 in which a plurality of storage elements 101 is arranged in a two-dimensional array, a control circuit 105, and a read circuit 107.

Each of the storage elements 101 is configured to transition to any of a plurality of states in accordance with an applied voltage. As a specific example, the storage element 101 may be configured to transition to any of a plurality of states (for example, the storage elements 101 transition to states different from each other) in accordance with a direction of an applied voltage. Furthermore, the storage element 101 may be configured so that a state of the storage element 101 transitions in a case where an applied voltage is equal to or higher than a certain voltage (that is, equal to or higher than a threshold value). In other words, the storage element 101 may be configured so that the state of the storage element 101 transitions in a case where a current of a certain level or more flows through the storage element 101. On the basis of such a configuration, each of at least two or more states among the plurality of possible states of the storage element 101 is associated with data different from each other (such as “0” and “1”, for example). With such a configuration, for example, data to be written can be held as a state of one storage element 101 or a combination of respective states of a plurality of storage elements 101.

As the storage element 101, for example, a magnetoresistive effect element such as a magnetic tunnel junction element (hereinafter also referred to as “MTJ element”) can be applied. Furthermore, as the storage element 101, another element different from the magnetoresistive effect element can be applied as long as the another element has the above-described characteristics. Note that, in the example illustrated in FIG. 1, a detailed circuit configuration such as various wirings for applying a voltage to each of the storage elements 101 and other elements are not illustrated. An example of a circuit configuration around the storage element 101 will be described later separately.

The control circuit 105 controls various operations relating to writing of data to at least a part of the plurality of storage elements 101 forming the element array 103 and reading of data from at least a part of the storage elements 101.

As a specific example, the control circuit 105 selects at least a part of the storage elements 101 in accordance with data to be written (Write Data), and controls an electrical connection relationship between the part of the storage elements 101 and a power supply voltage (not illustrated in FIG. 1) so that a predetermined voltage is applied to the part of the storage elements 101. As a result, the predetermined voltage is applied to a storage element 101 to which data is to be written, and a state of the storage element 101 transitions in accordance with the applied voltage.

Furthermore, the control circuit 105 controls an electrical connection relationship between at least a part of the storage elements 101 and the read circuit 107 so that data according to a state of the part of the storage elements 101 is read as read data (Read Data) by the read circuit 107 to be described later. As a result, a signal having a level according to a state of a storage element 101 from which data is to be read is output from the element array 103 to the read circuit 107, and the read circuit 107 can output, to a predetermined output destination, read data according to the level of the signal from the element array 103.

Note that, in the semiconductor storage device 100 according to the present embodiment, the control circuit 105 assigns at least two or more storage elements 101 as one bit. That is, one memory cell that holds data corresponding to one bit may include two or more storage elements 101. Note that, in this case, the control circuit 105 may control the selection of the storage elements 101 in a bit unit (that is, in a unit of two or more storage elements 101 constituting one memory cell) when writing data or reading data.

Furthermore, the control circuit 105 associates an address associated with a bit (software address) with an address associated with two or more storage elements 101 (that is, memory cell) (hardware address). Thus, the two or more storage elements 101 are assigned to the bit. With such a configuration, even in a case where an abnormality has occurred in at least a part of the storage elements 101 assigned to a certain bit (for example, in a case where held information has been illegally rewritten), it is possible to perform control so that the storage element 101 in which the abnormality has occurred is not used, by reassigning another storage element 101 (storage element 101 in which no abnormality has occurred) to the bit. Note that the control circuit 105 corresponds to an example of a “control unit”.

The read circuit 107 outputs, to the predetermined output destination, the data based on the level of the signal output from the element array 103 in accordance with the state of the storage element 101 selected under the control of the control circuit 105.

Furthermore, the read circuit 107 may recognize, on the basis of the level of the signal output from the element array 103, the state of the storage element 101 from which data is to be read, and determine, in accordance with a result of the recognition, whether or not the data (for example, the bit) according to the state of the storage element 101 is abnormal (that is, whether or not the data has been rewritten by an external factor). At this time, the read circuit 107 may notify the control circuit 105 of information regarding a bit (in other words, storage element 101) for which data is determined to be abnormal. As a result, for example, the control circuit 105 can also assign, to the bit for which the abnormality of the data has been detected, another storage element 101 (that is, a spare storage element 101 in which no abnormality occurs in the data) in place of the storage element 101 assigned at that time (that is, the storage element 101 in which the abnormality has occurred in the data). Note that a portion of the read circuit 107 that performs the determination corresponds to an example of a “determination unit”.

Note that a part of components of the above-described semiconductor storage device 100 may be provided outside the semiconductor storage device 100. As a specific example, at least a part of components of the read circuit 107 (for example, a component corresponding to the determination unit) may be provided outside the semiconductor storage device 100. Similarly, at least a part of components of the control circuit 105 may be provided outside the semiconductor storage device 100.

The example of the schematic functional configuration of the semiconductor storage device according to the embodiment of the present disclosure has been described above with reference to FIG. 1.

### 2. Outline of Magnetic Tunnel Junction Element

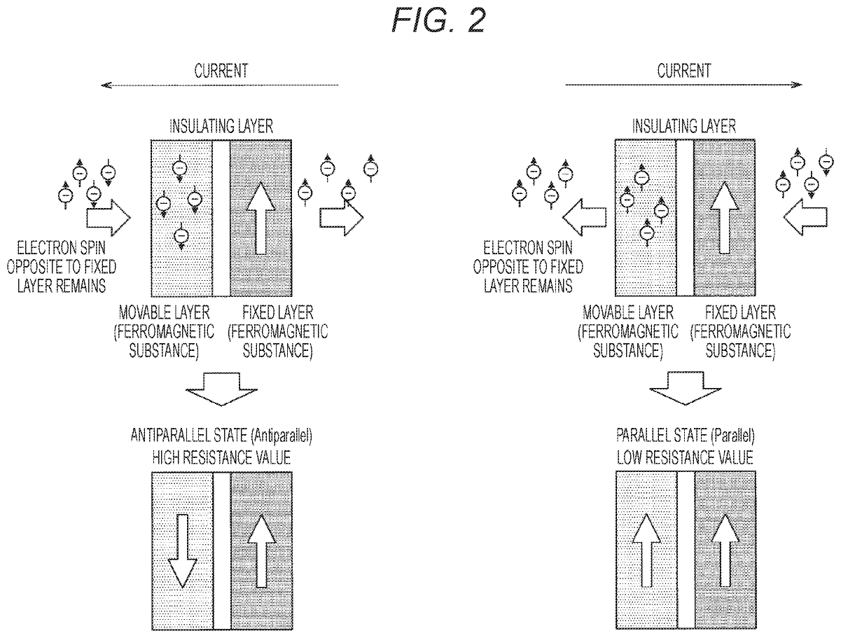

Next, an outline of an MTJ element applicable as a storage element to the semiconductor storage device according to the embodiment of the present disclosure will be described. For example, FIG. 2 is an explanatory diagram for describing the outline of the MTJ element.

The MTJ element is applied as a storage element to a semiconductor storage device called spin transfer torque-magnetic random access memory (STT-MRAM). The STT-MRAM is a semiconductor storage device that adopts a spin injection writing method in which magnetization is inverted by spin transfer torque, and data is stored in accordance with a magnetization direction of a magnetic substance.

Specifically, as illustrated in FIG. 2, the MTJ element is configured by magnetic tunnel junction in which a tunnel insulating layer is laminated between a magnetic layer whose magnetization is fixed (hereinafter also referred to as “fixed layer”) and a magnetic layer whose magnetization is not fixed (hereinafter also referred to as “movable layer”). On the basis of such a configuration, when spin electrons are injected into the MTJ element, a spin direction inside a magnetic substance (movable layer) is controlled. In FIG. 2, arrows shown on the fixed layer and the movable layer schematically indicate magnetization directions of magnetic substances.

Specifically, a diagram illustrated on the left side of FIG. 2 illustrates an example of a case where the MTJ element is controlled so that a current of a certain level or more flows from the fixed layer side to the movable layer side. In this case, electrons are injected into the MTJ element from the movable layer side to the fixed layer side, and electrons having spins opposite to those of electrons held in the fixed layer are held in the movable layer. As a result, the magnetization direction of the movable layer is opposite to that of the fixed layer. That is, the magnetization directions of the fixed layer and the movable layer are in an antiparallel state (Antiparallel).

Furthermore, a diagram illustrated on the right side of FIG. 2 illustrates an example of a case where the MTJ element is controlled so that a current of a certain level or more flows from the movable layer side to the fixed layer side. In this case, electrons are injected into the MTJ element from the fixed layer side to the movable layer side, and electrons having the same spins as those of the electrons held in the fixed layer are transmitted more from the fixed layer side to the movable layer side. As a result, the electrons having the same spins as those of the electrons held in the fixed layer are held in the movable layer, and the magnetization direction of the movable layer is the same as that of the fixed layer. That is, the magnetization directions of the fixed layer and the movable layer are in a parallel state (Parallel).

As described above, in a case where a current of a certain level or more flows, the MTJ element transitions to either the parallel state or the antiparallel state in accordance with a direction in which the current flows. Therefore, for example, it is possible to use the MTJ element as a rewritable storage element by associating each of the parallel state and the antiparallel state with data different from each other (such as “0” and “1”, for example). Note that the MTJ element exhibits a higher resistance value in the case of transitioning to the antiparallel state than in the case of transitioning to the parallel state. Therefore, for example, by detecting the element resistance of the MTJ element, it is possible to recognize whether the MTJ element has transitioned to the parallel state or the antiparallel state.

The outline of the MTJ element applicable as a storage element to the semiconductor storage device according to the embodiment of the present disclosure has been described above with reference to FIG. 2.

### 3. COMPARATIVE EXAMPLE

Next, in order to make characteristics of the semiconductor storage device according to the present embodiment easier to understand, an example of a semiconductor storage device to which a magnetoresistive effect element such as an MTJ element is applied as a storage element will be described as a comparative example.

<3.1. First Comparative Example>

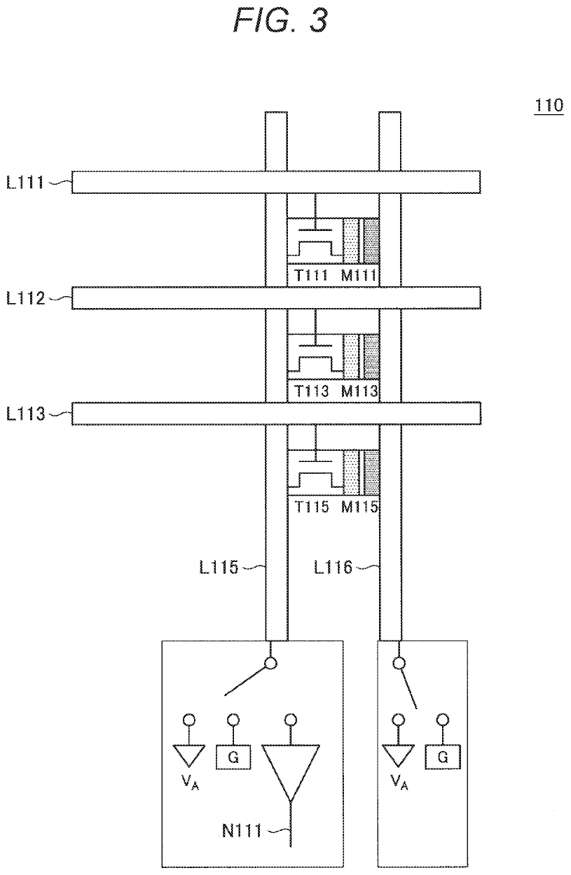

First, an outline of a semiconductor storage device according to a first comparative example will be described. For example, FIG. 3 is an explanatory diagram for describing an example of a schematic configuration of the semiconductor storage device according to the first comparative example, and schematically illustrates an example of an electrical connection relationship near a memory cell in which data corresponding to one bit is stored. A semiconductor storage device 110 according to the first comparative example illustrated in FIG. 3 is one in which one memory cell includes one MOS transistor and one MTJ element (that is, a semiconductor storage device having a 1T-1MTJ configuration). In FIG. 3, each of reference numerals M111, M113, and M115 indicates an MTJ element. Furthermore, each of reference numerals T111, T113, and T115 indicates a selection transistor. Note that, in the following description, the MTJ elements M111, M113, and M115 may be referred to as “MTJ elements M110” in a case where the MTJ elements M111, M113, and M115 are not particularly distinguished. Furthermore, the selection transistors T111, T113, and T115 may be referred to as “selection transistors T110” in a case where the selection transistors T111, T113, and T115 are not particularly distinguished.

The MTJ elements M110 and the selection transistors T110 are connected in series to constitute one memory cell, and are arranged so as to bridge signal lines L115 and L116. That is, each of the MTJ element M111 and the selection transistor T111, the MTJ element M113 and the selection transistor T113, and the MTJ element M115 and the selection transistor T115 constitutes one memory cell. Note that, at this time, each of the MTJ elements M111, M113, and M115 is arranged so as to have a similar electrical connection relationship with each of the signal lines L115 and L116. For example, in the example illustrated in FIG. 3, in each of the MTJ elements M111, M113, and M115, one of a fixed layer and a movable layer (for example, the movable layer) is connected to the signal line L115 side via corresponding one of the selection transistors T110, and the other (for example, the fixed layer) is connected to the signal line L116 side.

Furthermore, control lines L111, L112, and L113 are connected to gate terminals (hereinafter, also referred to as “control terminals”) of the selection transistors T111, T113, and T115, respectively. On the basis of such a configuration, the selection transistor T111 becomes conductive (hereinafter, also referred to as “on-state”) on the basis of a control signal supplied to the gate terminal via the control line L111. Similarly, the selection transistor T113 enters the on-state on the basis of a control signal supplied to the gate terminal via the control line L112. Furthermore, the selection transistor T115 enters the on-state on the basis of a control signal supplied to the gate terminal via the control line L113.

One of the signal lines L115 and L116 is connected to a potential different from a potential of the other when data is written. On the basis of such a configuration, when the selection transistors T110 are controlled to be in the on-state, a voltage according to a potential difference between the signal lines L115 and L116 is applied to the MTJ elements M110 connected to the selection transistors T110. At this time, in a case where the voltage according to the potential difference between the signal lines L115 and L116 is equal to or higher than a predetermined voltage (that is, equal to or higher than a threshold value), a certain current or more flows to the MTJ elements M110, and states of the MTJ elements M110 transition to the parallel state or the antiparallel state. Note that, whether the states of the MTJ elements M110 transition to the parallel state or the antiparallel state at this time is determined in accordance with a direction of the current flowing through the MTJ elements M110 (in other words, a direction of the applied voltage). That is, whether the states of the MTJ elements M110 transition to the parallel state or the antiparallel state is determined depending on which of the signal lines L115 and L116 has a higher potential.

As a more specific example, when data is written, one of the signal lines L115 and L116 is connected to a power supply voltage V_{A} (or a predetermined potential V_{A}) and the other is connected to a ground GND. Note that, in this case, a potential of the power supply voltage V_{A} is higher than a potential of the ground GND (that is, V_{A}>GND). As a result, the voltage V_{A} is applied to one of the MTJ elements M110, which is selected by corresponding one of the selection transistors T110 controlled to be in the on-state. Note that, in the example illustrated in FIG. 3, in a case where the signal line L115 is connected to the power supply voltage V_{A} and the signal line L116 is connected to the ground GND, the MTJ elements M110 are in the parallel state, and resistance values of the MTJ elements M110 are lower. On the other hand, in a case where the signal line L115 is connected to the ground GND and the signal line L116 is connected to the power supply voltage V_{A}, the MTJ elements M110 are in the antiparallel state, and the resistance values of the MTJ elements M110 are higher. Note that, in the following description, for convenience, in the example illustrated in FIG. 3, a case where the MTJ elements M110 are in the parallel state is associated with “H data”, and a case where the MTJ elements M110 are in the antiparallel state is associated with “L data”.

Furthermore, the signal line L115 functions as a read line for data from each memory cell (in other words, data according to the state of each MTJ element M110) when data is read. That is, when data is read, the signal line L115 is connected to a node N111 connected to the read circuit, and a signal according to a state of one of the MTJ elements M110, which is selected by corresponding one of the selection transistors T110 controlled to be in the on-state, is read to the read circuit.

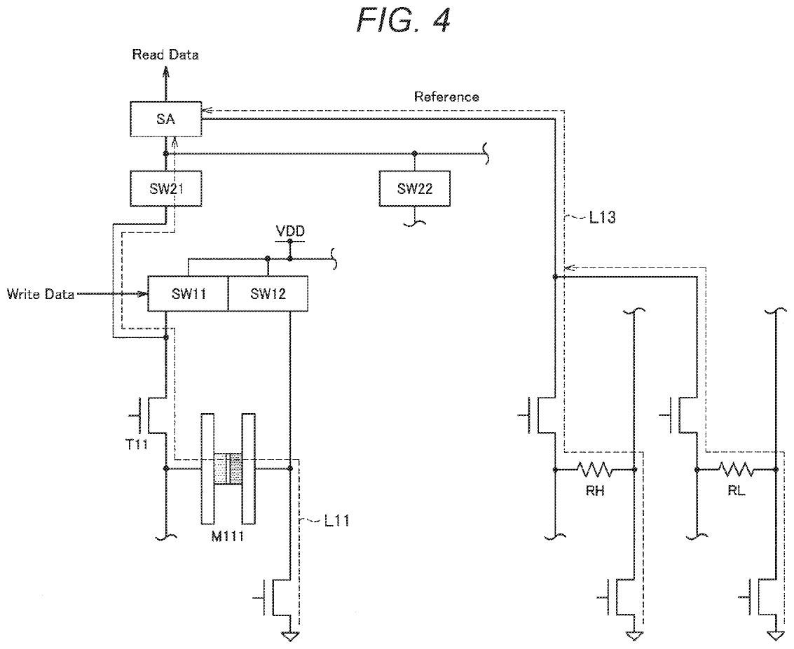

Furthermore, when data is read, on the basis of a level of the signal output to the read circuit in accordance with the state of the selected one of the MTJ elements M110, it is determined whether data according to the signal (that is, read data) corresponds to the “H data” or the “L data”. For example, FIG. 4 is a schematic circuit diagram illustrating an example of a configuration of the semiconductor storage device according to the first comparative example, and illustrates an example of a configuration focusing on reading of data from the MTJ element. Note that FIG. 4 schematically illustrates a connection relationship among elements, focusing on a case where data according to a state of the SMJ element M111 is read. In FIG. 4, reference numerals SW11, SW12, SW21, and SW22 schematically indicate switches for selecting one of the MTJ elements M110 (in other words, a memory cell) to which data is written when data is written, or from which data is read when data is read.

That is, in the example illustrated in FIG. 4, the switches SW11, SW12, SW21, and SW22 are controlled to select the MTJ element M111 from which data is read. At this time, a signal according to the state of the MTJ element M111 is input to a sense amplifier SA via a path indicated by a reference numeral L11, and is amplified by the sense amplifier SA to be a read signal. That is, it is determined whether the read data corresponds to the H data or the L data in accordance with a level of the read signal.

Note that, in the semiconductor storage device having the 1T-1MTJ configuration as illustrated in FIG. 4, it is determined whether the level of the read signal corresponds to the H data or the L data, for example, in accordance with comparison between the level of the read signal and a level of a predetermined reference signal. For example, in the example illustrated in FIG. 4, a signal input through a path indicated by a reference numeral L13 is used as the reference signal. Note that the level of the reference signal is determined on the basis of resistors RH and RL. Specifically, in the example illustrated in FIG. 4, the level of the reference signal is a level according to (RH+RL)/2.

Meanwhile, in the semiconductor storage device having the 1T-1MTJ configuration described with reference to FIGS. 3 and 4, the level of the read signal may vary depending on variations among elements referred to when data is read (for example, element variations of the MTJ elements M110). If such variations in the read signal become larger, for example, a margin for controlling the level of the signal may be insufficient. Furthermore, as illustrated in FIG. 4, the semiconductor storage device having the 1T-1MTJ configuration requires a configuration for outputting a reference signal separately. The need for an additional circuit as described above may reduce a yield relating to manufacture of the semiconductor storage device. Therefore, an example of a configuration for solving such a problem will be described later as a second comparative example separately.

<3.2. Second Comparative Example>

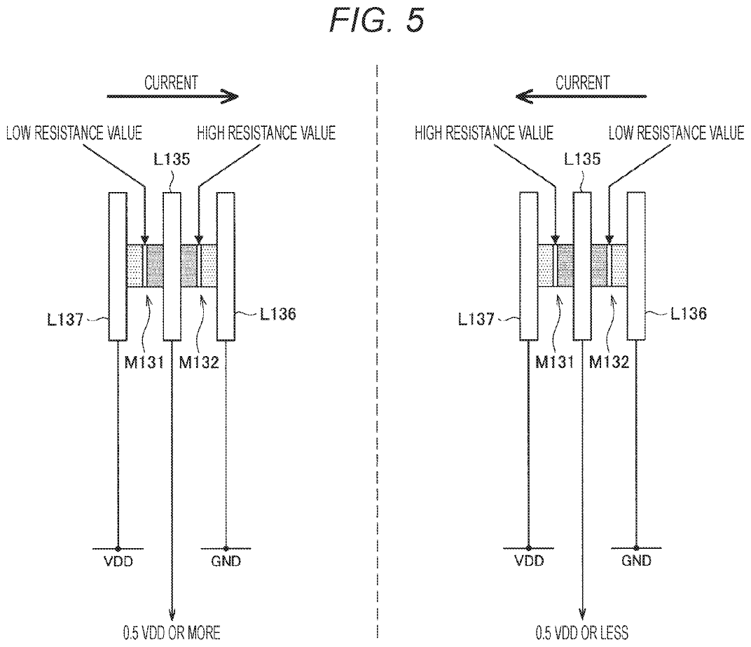

Next, an outline of a semiconductor storage device according to the second comparative example will be described. For example, FIG. 5 is an explanatory diagram for describing an example of a schematic configuration of a memory cell in the semiconductor storage device according to the second comparative example.

As illustrated in FIG. 5, in the semiconductor storage device according to the second comparative example, one memory cell includes two MTJ elements M131 and M132. That is, two two MTJ elements M131 and M132 are assigned to one bit. Specifically, in the example illustrated in FIG. 5, a signal line L135 is commonly connected to one of a fixed layer and a movable layer included in each of the MTJ elements M131 and M132. Furthermore, a signal line is individually connected to the other of the fixed layer and the movable layer included in each of the MTJ elements M131 and M132 separately. Specifically, a signal line L137 is connected to the other of the fixed layer and the movable layer included in the MTJ element M131. Furthermore, a signal line L136 is connected to the other of the fixed layer and the movable layer included in the MTJ element M132. On the basis of such a configuration, for example, when a current flows between the signal lines L137 and L136, the MTJ elements M131 and M132 transition to states different from each other.

For example, in a diagram illustrated on the left side of FIG. 5, the signal line L137 is connected to a power supply voltage VDD and the signal line L136 is connected to a ground GND, and a current flows from the signal line L137 to the signal line L136 via the MTJ elements M131 and M132. In this case, the MTJ element M131 exhibits a low resistance value and the MTJ element M132 exhibits a high resistance value, and a potential of the signal line L135 is 0.5 VDD or more.

On the other hand, in a diagram illustrated on the right side of FIG. 5, the signal line L137 is connected to the ground GND and the signal line L136 is connected to the power supply voltage VDD, and a current flows from the signal line L136 to the signal line L137 via the MTJ elements M132 and M131. In this case, the MTJ element M131 exhibits a high resistance value and the MTJ element M131 exhibits a low resistance value, and the potential of the signal line L135 is 0.5 VDD or less.

That is, in the example illustrated in FIG. 5, the potential of the signal line L135 (in other words, a level of a read signal) is relatively determined in accordance with respective states of the MTJ elements M131 and M132. As a result, components resulting from respective element variations of the MTJ elements M131 and M132 are canceled out, and it is possible to further reduce influence of the variations between the elements, as compared with the semiconductor storage device according to the first comparative example described with reference to FIGS. 3 and 4.

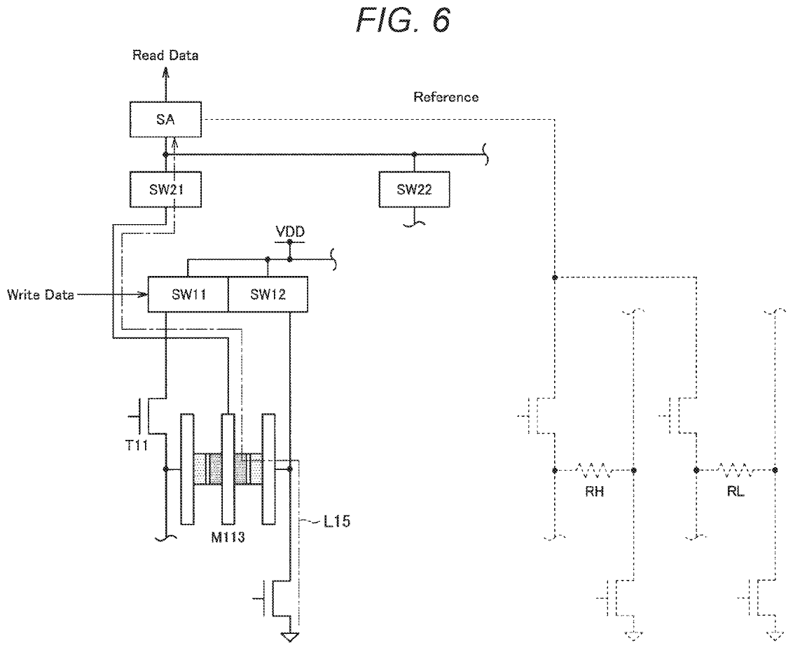

Furthermore, FIG. 6 is a schematic circuit diagram illustrating an example of a configuration of the semiconductor storage device according to the second comparative example, and illustrates an example of a configuration focusing on reading of data from the MTJ elements. In FIG. 6, components denoted by similar reference numerals to those in FIG. 4 indicate similar components to those in the example illustrated in FIG. 4. In the example illustrated in FIG. 6, a signal according to states of the MTJ elements M131 and M132 is input to a sense amplifier SA via a path indicated by a reference numeral L15, and is amplified by the sense amplifier SA to be a read signal.

Note that, as described above, in the semiconductor storage device according to the second comparative example, the level of the read signal is relatively determined in accordance with the respective states of the MTJ elements M131 and M132, and the components resulting from the respective element variations of the MTJ elements M131 and M132 are canceled out. With such characteristics, in the semiconductor storage device according to the second comparative example, there is no need to provide a configuration for generating a reference signal in the semiconductor storage device according to the second comparative example described with reference to FIG. 4 (that is, a configuration shown by a broken line in FIG. 6). That is, in the semiconductor storage device according to the second comparative example, it is also possible to expect an effect of further improving a yield relating to manufacture of the semiconductor storage device, as compared with the first comparative example.

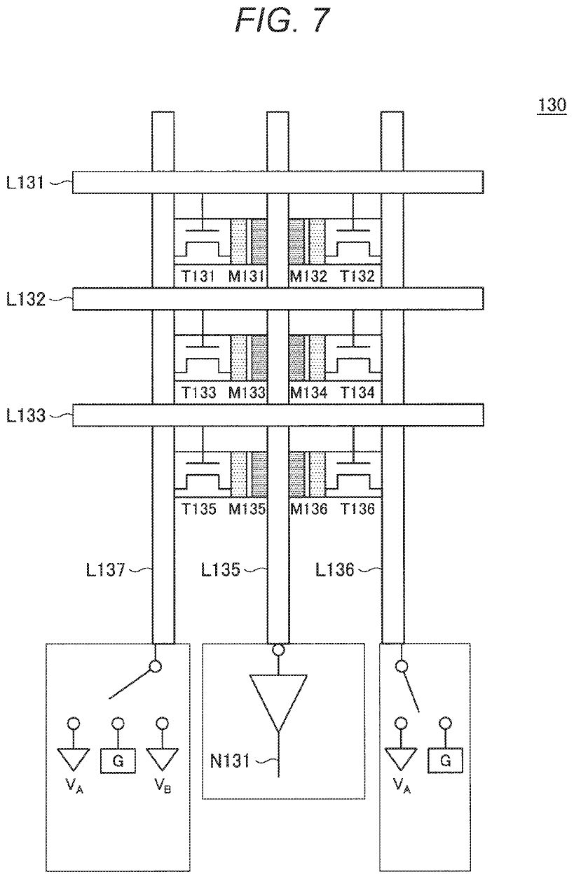

Here, an example of the configuration and control of the semiconductor storage device according to the second comparative example will be described in more detail with reference to FIGS. 7 to 10.

For example, FIG. 7 is an explanatory diagram for describing an example of a schematic configuration of the semiconductor storage device according to the second comparative example, and schematically illustrates an example of an electrical connection relationship near a memory cell in which data corresponding to one bit is stored. A semiconductor storage device 130 according to the second comparative example illustrated in FIG. 7 is one in which one memory cell includes two MOS transistors and two MTJ elements (that is, a semiconductor storage device having a 2T-2MTJ configuration). In FIG. 7, each of reference numerals M131 to M116 indicates an MTJ element. Furthermore, each of reference numerals T131 to T136 indicates a selection transistor. Note that, in the following description, the MTJ elements M131 to M136 may be referred to as “MTJ elements M130” in a case where the MTJ elements M131 to M136 are not particularly distinguished. Furthermore, the selection transistors T131 to T136 may be referred to as “selection transistors T130” in a case where the selection transistors T131 to T136 are not particularly distinguished.

Furthermore, in FIG. 7, signal lines L135 to L137 correspond to the signal lines L135 to L137 in the example illustrated in FIG. 5. That is, the MTJ elements M131, M133, and M135 in FIG. 7 each correspond to the MTJ element M131 in the example illustrated in FIG. 5. Similarly, the MTJ elements M132, M134, and M136 in FIG. 7 each correspond to the MTJ element M132 in the example illustrated in FIG. 5.

In the semiconductor storage device 130 illustrated in FIG. 7, the selection transistors T130 are each individually connected to corresponding one of two MTJ elements M130 constituting one memory cell. At this time, one MTJ element M130 and one selection transistor T130 connected to each other are connected in series. As a specific example, the selection transistor T131 is connected in series to the MTJ element M131, and the MTJ element M131 and the selection transistor T131 are arranged so as to bridge the signal lines L135 and L137. Furthermore, the selection transistor T132 is connected in series to the MTJ element M132, and the MTJ element M132 and the selection transistor T132 are arranged so as to bridge the signal lines L135 and L136. On the basis of such a configuration, the MTJ elements M131 and M132 and the selection transistors T131 and T132 constitute one memory cell.

Similarly, each of a combination of the MTJ elements M133 and M134 and the selection transistors T133 and T134 and a combination of the MTJ elements M135 and M136 and the selection transistors T135 and T136 constitutes one memory cell. Note that, at this time, each of the MTJ elements M131, M133, and M135 is arranged so as to have a similar electrical connection relationship with each of the signal lines L135 and L137. For example, in the example illustrated in FIG. 7, in each of the MTJ elements M131, M133, and M135, one of a fixed layer and a movable layer (for example, the fixed layer) is connected to the signal line L135 side, and the other (for example, the movable layer) is connected to the signal line L137 side via corresponding one of the selection transistors T130. Furthermore, in each of the MTJ elements M132, M134, and M136, one of a fixed layer and a movable layer (for example, the fixed layer) is connected to the signal line L135 side, and the other (for example, the movable layer) is connected to the signal line L136 side via corresponding one of the selection transistors T130.

Furthermore, a control line L131 is connected to a gate terminal (that is, control terminal) of each of the selection transistors T131 and T132. On the basis of such a configuration, each of the selection transistors T131 and T132 enters an on-state on the basis of a control signal supplied to the gate terminal via the control line L131. Similarly, a control line L132 is connected to a gate terminal of each of the selection transistors T133 and T134. That is, each of the selection transistors T133 and T134 enters the on-state on the basis of a control signal supplied to the gate terminal via the control line L132. Furthermore, the control line L132 is connected to a gate terminal of each of the selection transistors T135 and T136. That is, each of the selection transistors T135 and T136 enters the on-state on the basis of a control signal supplied to the gate terminal via a control line L133.

One of the signal lines L136 and L137 is connected to a potential different from a potential of the other when data is written. Furthermore, the signal line L135 functions as a read line for reading data according to a state of each MTJ element M130 (in other words, a signal according to a state of each MTJ element M130) from each memory cell when data is read. Therefore, the signal line L135 is connected to, for example, a node N131 connected to a read circuit. With such a configuration, when a voltage is applied between the signal lines L136 and L137, a signal having a level according to a potential of the signal line L135 is output to the read circuit.

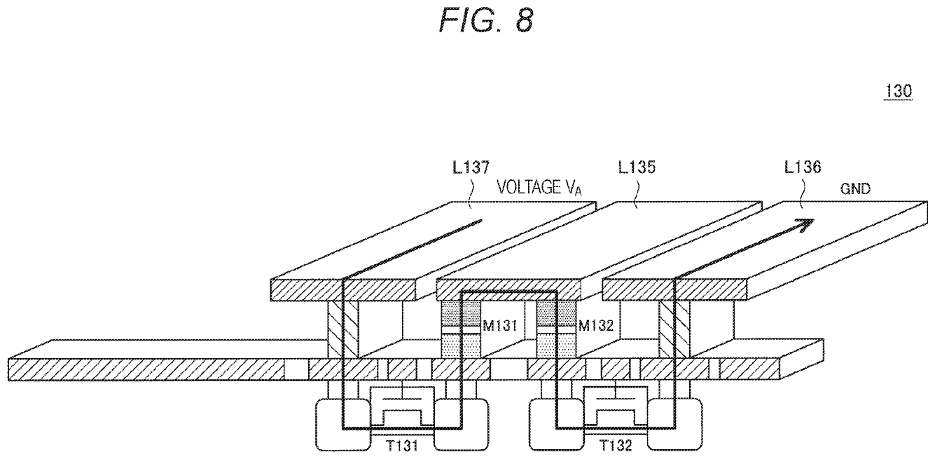

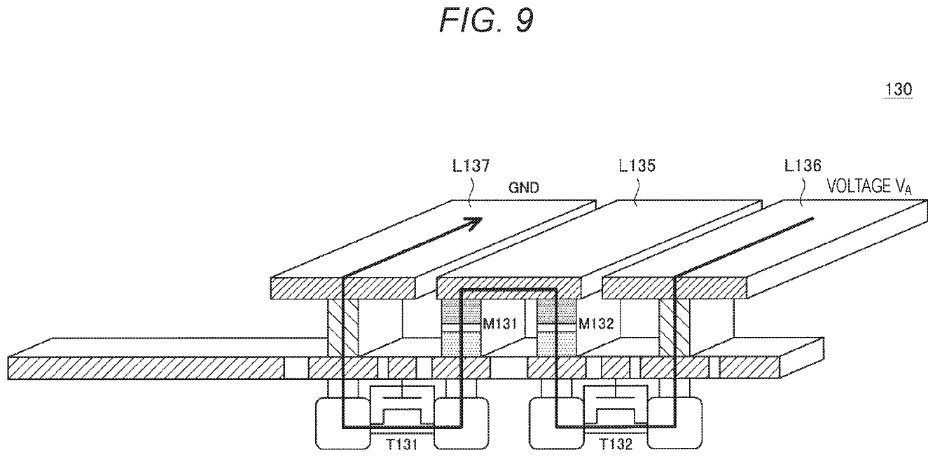

Here, an example of control relating to writing of data in the semiconductor storage device 130 according to the second comparative example will be described with reference to FIGS. 8 and 9. FIGS. 8 and 9 are explanatory diagrams for describing an example of control of the semiconductor storage device 130 according to the second comparative example, and illustrate an example of control relating to voltage application to the MTJ elements M130 when data is written. Note that, in the following description, for convenience, FIG. 8 illustrates an example of writing H data to a memory cell, and FIG. 9 illustrates an example of writing L data to a memory cell.

First, an example of control in a case where the H data is written to a memory cell will be described with reference to FIG. 8. In this case, the signal line L137 is connected to a power supply voltage V_{A} and the signal line L136 is connected to a ground GND. Note that V_{A}>GND. Next, when the MTJ elements M131 and M132 are selected by the selection transistors T131 and T132 controlled to be in the on-state, a voltage according to a potential difference between the signal lines L137 and L136 is applied to the MTJ elements M131 and M132. That is, a current flows from the signal line L137 to the signal line L136 via the MTJ element M131, the signal line L135, and the MTJ element M132. At this time, in a case where the voltage applied to each of the MTJ elements M131 and M132 is equal to or higher than a predetermined voltage (that is, equal to or higher than a threshold value), a current of a certain level or more flows through the MTJ elements M131 and M132. As a result, the respective states of the MTJ elements M131 and M132 transition to the parallel state or the antiparallel state in accordance with a direction in which the current flows (that is, a direction in which the voltage is applied). Specifically, in the case of the example illustrated in FIG. 8, the MTJ element M131 transitions to the antiparallel state and has a lower resistance value, and the MTJ element M132 transitions to the parallel state and has a higher resistance value.

Next, an example of control in a case where the L data is written to a memory cell will be described with reference to FIG. 9. In this case, the signal line L137 is connected to the ground GND and the signal line L136 is connected to the power supply voltage V_{A}. Next, when the MTJ elements M131 and M132 are selected by the selection transistors T131 and T132 controlled to be in the on-state, a voltage according to a potential difference between the signal lines L137 and L136 is applied to the MTJ elements M131 and M132. That is, a current flows from the signal line L136 to the signal line L137 via the MTJ element M132, the signal line L135, and the MTJ element M131. At this time, in a case where the voltage applied to each of the MTJ elements M131 and M132 is equal to or higher than a predetermined voltage (that is, equal to or higher than a threshold value), a current of a certain level or more flows through the MTJ elements M131 and M132. As a result, the respective states of the MTJ elements M131 and M132 transition to the parallel state or the antiparallel state in accordance with a direction in which the current flows (that is, a direction in which the voltage is applied). Specifically, in the case of the example illustrated in FIG. 9, the MTJ element M131 transitions to the parallel state and has a higher resistance value, and the MTJ element M132 transitions to the antiparallel state and has a lower resistance value.

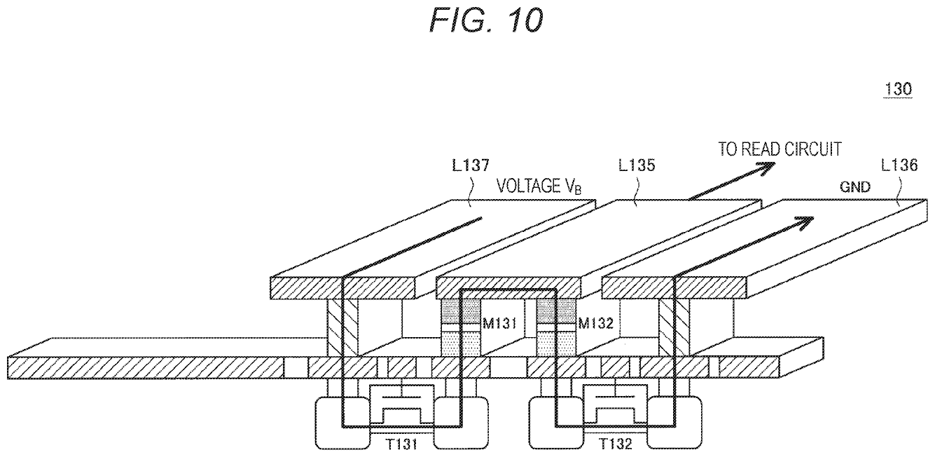

Next, an example of control relating to reading of data in the semiconductor storage device 130 according to the second comparative example will be described with reference to FIG. 10. FIG. 10 is an explanatory diagram for describing an example of the control of the semiconductor storage device 130 according to the second comparative example, and illustrates an example of control relating to reading of data according to the states of the MTJ elements M130.

When data is read, the signal line L137 is connected to a power supply voltage V_{B}, and the signal line L136 is connected to the ground GND. Note that V_{A}>V_{B}>GND. Next, when the MTJ elements M131 and M132 are selected by the selection transistors T131 and T132 controlled to be in the on-state, a voltage according to a potential difference between the signal lines L137 and L136 is applied to the MTJ elements M131 and M132. That is, a current flows from the signal line L137 to the signal line L136 via the MTJ element M131, the signal line L135, and the MTJ element M132. Note that the voltage V_{B} is set so that a current flows to each of the MTJ elements M131 and M132 to the extent that the respective states of the MTJ elements M131 and M132 do not transition. Furthermore, the signal line L135 is connected to the node (node N131 illustrated in FIG. 7) connected to the read circuit. As a result, a signal according to a potential of the signal line L135 is amplified by the sense amplifier (for example, sense amplifier SA illustrated in FIG. 6) and output as a read signal to the read circuit. Note that, as described above with reference to FIG. 5, a level of the read signal (in other words, the potential of the signal line L135) is relatively determined in accordance with the respective states of the MTJ elements M131 and M132. That is, the read circuit can determine whether the read data corresponds to the H data or the L data in accordance with the level of the read signal.

As described above, the example of the semiconductor storage device to which a magnetoresistive effect element such as an MTJ element is applied as a diagram storage element has been described with reference to FIGS. 3 to 10 as the first and second comparative examples.

### 4. TECHNICAL ISSUES

Next, technical issues of the semiconductor storage device according to the embodiment of the present disclosure will be described.

In a storage device (for example, an MRAM or the like) that uses a magnetoresistive effect element such as an MTJ element as a storage element, information held in the storage element may be unintentionally or illegally rewritten due to influence of an external factor such as a strong external magnetic field from the outside. As described above, in the case where the information held in the storage element has been rewritten due to the influence of an external factor such as a strong magnetic field from the outside, it may be difficult to detect that the information has been rewritten, depending on a configuration of the storage device. As a specific example, in the semiconductor storage device according to the first comparative example described above, in the case where the information held in the storage element has been rewritten due to the influence of an external factor, it is difficult to detect that the information has been rewritten.

In particular, in recent years, a storage device such as an MRAM may be used for an electronic apparatus that requires a higher security level, such as an apparatus used for authentication. In such an apparatus, if it is not possible to detect that the information held in the storage device has been illegally rewritten, it may be difficult to prevent a situation where the rewritten information is illegally used (for example, spoofing, access to personal information, or the like). Therefore, in such an apparatus, it is required to introduce a technology capable of detecting that information held in the storage device has been rewritten even in a case where the information has been illegally rewritten.

In view of such a situation, in the present disclosure, there is proposed a technology of capable of detecting that information held in a storage element has been rewritten even in a case where the information has been unintentionally or illegally rewritten due to the influence of an external factor such as a strong magnetic field from the outside.

### 5. TECHNICAL CHARACTERISTICS

The technical characteristics of the semiconductor storage device according to the embodiment of the present disclosure will be described below.

<5.1. Configuration>

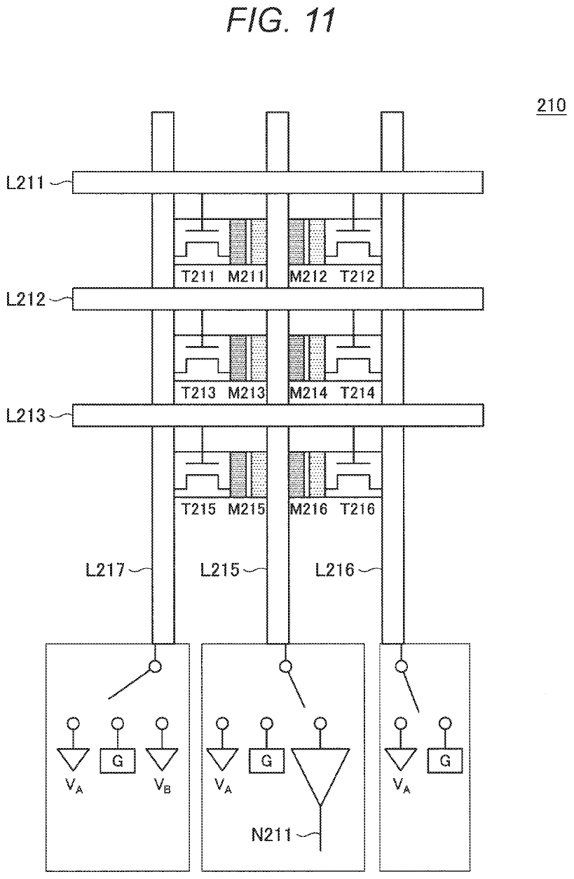

First, an example of a configuration of the semiconductor storage device according to the embodiment of the present disclosure will be described with reference to FIG. 11, focusing particularly on a configuration of a memory cell in which data corresponding to one bit is stored. FIG. 11 is an explanatory diagram for describing an example of a schematic configuration of the semiconductor storage device according to the present embodiment, and schematically illustrates an example of an electrical connection relationship near the memory cell.

The semiconductor storage device according to the present embodiment assigns a plurality of storage elements to one bit and controls respective states of the plurality of storage elements in accordance with write data. Furthermore, as a storage element, for example, a magnetoresistive effect element such as an MTJ element can be applied. Note that, in the following description, the description will be made assuming that an MTJ element is applied as a storage element.

A semiconductor storage device 210 illustrated in FIG. 11 is a semiconductor storage device having the 2T-2MTJ configuration in which one memory cell includes two MOS transistors and two MTJ elements. In FIG. 11, each of reference numerals M211 to M216 indicates an MTJ element. Furthermore, each of reference numerals T211 to T216 indicates a selection transistor. Note that, in the following description, the MTJ elements M211 to M216 may be referred to as “MTJ elements M210” in a case where the MTJ elements M211 to M216 are not particularly distinguished. Furthermore, the selection transistors T211 to T216 may be referred to as “selection transistors T210” in a case where the selection transistors T211 to T216 are not particularly distinguished.

Furthermore, in the semiconductor storage device 210 illustrated in FIG. 11, the selection transistors T210 are each individually connected to corresponding one of the two MTJ elements M210 constituting one memory cell. At this time, one MTJ element M210 and one selection transistor T210 connected to each other are connected in series. As a specific example, the selection transistor T211 is connected in series to the MTJ element M211, and the MTJ element M211 and the selection transistor T211 are arranged so as to bridge signal lines L215 and L217. Furthermore, the selection transistor T212 is connected in series to the MTJ element M212, and the MTJ element M212 and the selection transistor T212 are arranged so as to bridge the signal line L215 and a signal line L216. That is, the signal line L215 is commonly connected to each of the MTJ elements M211 and M213. Furthermore, a signal line (that is, signal lines L217 and L216) is individually connected to each of the MTJ elements M211 and M213 on a side opposite to the signal line L215 separately. On the basis of such a configuration, the MTJ elements M211 and M212 and the selection transistors T211 and T212 constitute one memory cell.

Similarly, each of a combination of the MTJ elements M213 and M214 and the selection transistors T213 and T214 and a combination of the MTJ elements M215 and M216 and the selection transistors T215 and T216 constitutes one memory cell. Note that, at this time, each of the MTJ elements M211, M213, and M215 is arranged so as to have a similar electrical connection relationship with each of the signal lines L215 and L217. For example, in the example illustrated in FIG. 11, in each of the MTJ elements M211, M213, and M215, one of a fixed layer and a movable layer (for example, the movable layer) is connected to the signal line L215 side, and the other (for example, the fixed layer) is connected to the signal line L217 side via corresponding one of the selection transistors T210 (that is, the selection transistor T211, T213, or T215). Furthermore, in each of the MTJ elements M212, M214, and M216, one of a fixed layer and a movable layer (for example, the fixed layer layer) is connected to the signal line L215 side, and the other (for example, the movable layer) is connected to the signal line L216 side via corresponding one of the selection transistors T210 (that is, selection transistor T212, T214, or T216).

Note that, as described above, in the semiconductor storage device 210 according to the present embodiment, two MTJ elements M210 constituting one memory cell each have a different connection relationship with the signal line L215. As a specific example, the movable layer side of the MTJ element M211 is connected to the signal line L215. On the other hand, the fixed layer side of the MTJ element M212 is connected to the signal line L215.

Furthermore, a control line L211 is connected to a gate terminal (that is, control terminal) of each of the selection transistors T211 and T212. On the basis of such a configuration, each of the selection transistors T211 and T212 enters an on-state on the basis of a control signal supplied to the gate terminal via the control line L211. Similarly, a control line L212 is connected to a gate terminal of each of the selection transistors T213 and T214. That is, each of the selection transistors T213 and T214 enters the on-state on the basis of a control signal supplied to the gate terminal via the control line L212. Furthermore, the control line L212 is connected to a gate terminal of each of the selection transistors T215 and T216. That is, each of the selection transistors T215 and T216 enters the on-state on the basis of a control signal supplied to the gate terminal via a control line L213.

The signal line L215 and each of the signal lines L216 and L217 are connected to potentials different from each other when data is written. For example, in a case where the signal line L215 is connected to a power supply voltage V_{A}, each of the signal lines L216 and L217 is connected to a ground GND. Furthermore, in a case where the signal line L215 is connected to the ground GND, each of the signal lines L216 and L217 is connected to the power supply voltage V_{A}. As described above, in the semiconductor storage device 210 according to the present embodiment, when data is written, two MTJ elements M210 (for example, MTJ elements M211 and M212) constituting one memory cell are connected in parallel. Furthermore, a direction of a current flowing through each MTJ element M210 (that is, a direction of an applied voltage) changes depending on which of the signal line L215 and each of the signal lines L216 and L217 has a higher potential.

Furthermore, the signal line L215 functions as a read line for reading data according to a state of each MTJ element M110 (in other words, a signal according to the state of each MTJ element M210) from each memory cell when data is read. Therefore, the signal line L215 is connected to a node N211 connected to a read circuit when data is read. With such a configuration, when a voltage is applied between the signal lines L216 and L217, a signal having a level according to a potential of the signal line L215 is output to the read circuit.

Note that, in the semiconductor storage device 210 according to the present embodiment, details of control relating to writing of data to each memory cell (that is, each MTJ element M210) and control relating to reading of data from each memory cell will be described later separately. Furthermore, in the example illustrated in FIG. 11, the signal line L215 corresponds to an example of a “first signal line”, and each of the signal lines L216 and L217 corresponds to an example of a “second signal line”.

The example of the configuration of the semiconductor storage device according to the embodiment of the present disclosure has been described above with reference to FIG. 11, focusing particularly on the configuration of the memory cell in which data corresponding to one bit is stored.

<5.2. Control>

Next, an example of control of the semiconductor storage device according to the present embodiment will be described, focusing particularly on control relating to each of writing of data and reading of data.

(Control Relating to Writing of Data)

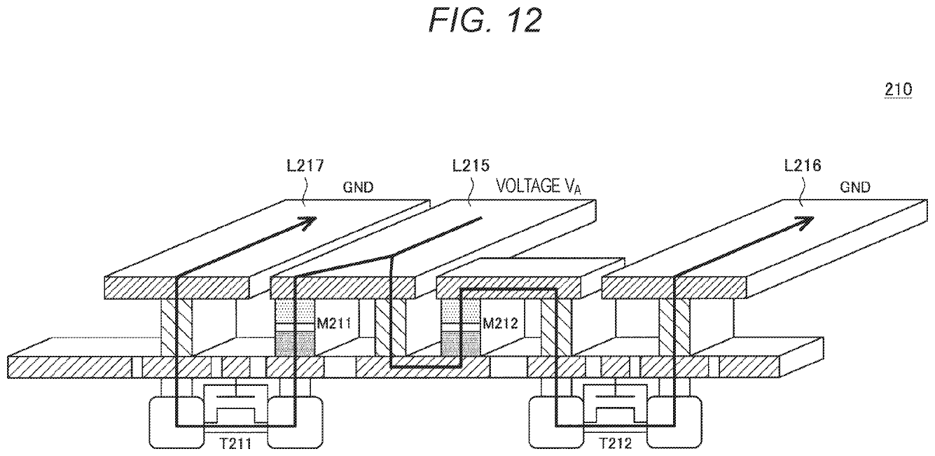

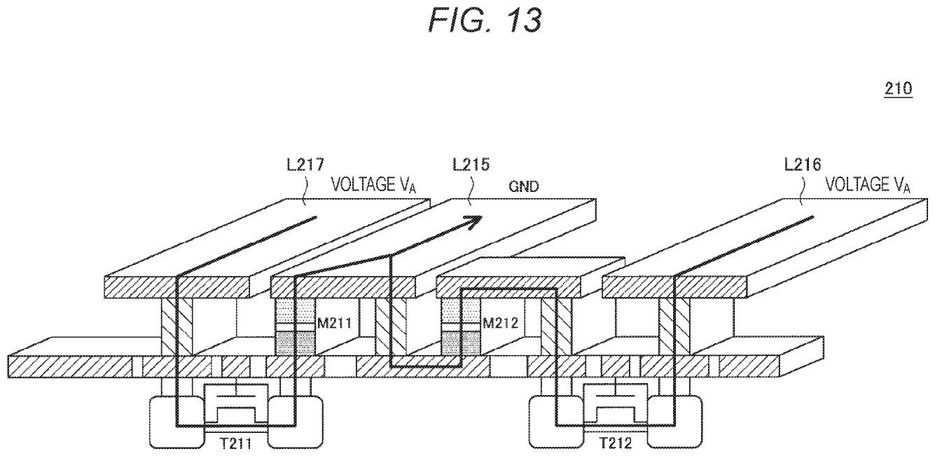

First, an example of control relating to writing of data in the semiconductor storage device 210 according to the present embodiment will be described with reference to FIGS. 12 and 13. FIGS. 12 and 13 are explanatory diagrams for describing an example of the control of the semiconductor storage device 210 according to the present embodiment, and illustrate an example of control relating to voltage application to the MTJ elements M210 when data is written. Note that, in the following description, for convenience, FIG. 12 illustrates an example of writing H data to a memory cell, and FIG. 13 illustrates an example of writing L data to a memory cell. Furthermore, FIGS. 12 and 13 also illustrate an example of a schematic configuration in a case where a memory cell of the semiconductor storage device 210 illustrated in FIG. 11 is implemented by a so-called laminated structure.

First, an example of control in a case where the H data is written to a memory cell will be described with reference to FIG. 12. In this case, for example, the signal line L215 is connected to the power supply voltage V_{A} and each of the signal lines L216 and L217 is connected to the ground GND. Note that V_{A}>GND. Next, when the MTJ elements M211 and M212 are selected by the selection transistors T211 and T212 controlled to be in the on-state, a voltage according to a potential difference between the signal line L215 and each of the signal lines L217 and L216 is applied to each of the MTJ elements M211 and M212. At this time, the MTJ elements M211 and M212 are connected in parallel, and a current flows from the signal line L215 to each of the signal lines L217 and L216 via corresponding one of the MTJ elements M210 and corresponding one of the selection transistors T210. Specifically, a current according to a potential difference between the signal line L215 and the signal line L217 flows from the signal line L215 to the signal line L217 via the MTJ element M211 and the selection transistor T211. Similarly, a current according to a potential difference between the signal line L215 and the signal line L216 flows from the signal line L215 to the signal line L216 via the MTJ element M212 and the selection transistor T212. At this time, in a case where the voltage applied to each of the MTJ elements M211 and M212 is equal to or higher than a predetermined voltage (that is, equal to or higher than a threshold value), a current of a certain level or more flows through the MTJ elements M211 and M212. As a result, respective states of the MTJ elements M211 and M212 transition to the parallel state or the antiparallel state in accordance with a direction in which the current flows (that is, a direction in which the voltage is applied). Specifically, in the case of the example illustrated in FIG. 12, the MTJ element M211 transitions to the antiparallel state and has a lower resistance value, and the MTJ element M212 transitions to the parallel state and has a higher resistance value.

Next, an example of control in a case where the L data is written to a memory cell will be described with reference to FIG. 13. In this case, for example, the signal line L215 is connected to the ground GND and each of the signal lines L216 and L217 is connected to the power supply voltage V_{A}. Next, when the MTJ elements M211 and M212 are selected by the selection transistors T211 and T212 controlled to be in the on-state, a voltage according to a potential difference between each of the signal lines L217 and L216 and the signal line L215 is applied to each of the MTJ elements M211 and M212. At this time, the MTJ elements M211 and M212 are connected in parallel, and a current flows from each of the signal lines L217 and L216 to the signal line L215 via corresponding one of the MTJ elements M210 and corresponding one of the selection transistors T210. Specifically, a current according to a potential difference between the signal line L217 and the signal line L215 flows from the signal line L217 to the signal line L215 via the selection transistor T211 and the MTJ element M211. Similarly, a current according to a potential difference between the signal line L216 and the signal line L215 flows from the signal line L216 to the signal line L215 via the selection transistor T212 and the MTJ element M212. At this time, in a case where the voltage applied to each of the MTJ elements M211 and M212 is equal to or higher than a predetermined voltage (that is, equal to or higher than a threshold value), a current of a certain level or more flows through the MTJ elements M211 and M212. As a result, the respective states of the MTJ elements M211 and M212 transition to the parallel state or the antiparallel state in accordance with a direction in which the current flows (that is, a direction in which the voltage is applied). Specifically, in the case of the example illustrated in FIG. 13, the MTJ element M211 transitions to the parallel state and has a higher resistance value, and the MTJ element M212 transitions to the antiparallel state and has a lower resistance value.

As described above, in the semiconductor storage device 210 illustrated in FIG. 11, when data is written, two MTJ elements M210 constituting one memory cell are controlled to be in states different from each other. That is, the semiconductor storage device according to the present embodiment performs control so that a state of at least a part of a plurality of storage elements constituting one memory cell transitions to a state different from that of another storage element when data is written. With such a configuration, the semiconductor storage device according to the present embodiment can detect that data held in the MTJ elements M210 has been rewritten even in a case where the data has been unintentionally or illegally rewritten due to an external factor such as a strong magnetic field from the outside. Note that a mechanism for detecting that data has been rewritten due to an external factor (that is, a mechanism for detecting an abnormality in data) will be described later separately.

Furthermore, in the semiconductor storage device 210 illustrated in FIG. 11, when data is written, an electrical connection relationship between two MTJ elements M210 constituting one memory cell is controlled so that the elements constituting the memory cell are in parallel. Therefore, the semiconductor storage device 210 according to the present embodiment can further reduce a voltage applied to each MTJ element M210 when data is written, as compared with the semiconductor storage device 130 according to the second comparative example described above (see FIGS. 7 to 10). As a specific example, in a case where the MTJ elements are connected in series to apply a voltage as in the semiconductor storage device 130 according to the second comparative example, it is necessary to apply a voltage of about 2.0 V, which also includes a voltage applied to each selection transistor. On the other hand, in a case where the semiconductor storage device 210 according to the present embodiment is configured by application of similar MTJ elements to those used in the semiconductor storage device 130, it is possible to reduce an applied voltage to about 1.0 V. That is, the semiconductor storage device 210 according to the present embodiment can further reduce power consumption as compared with the semiconductor storage device 130 according to the second comparative example. Furthermore, it is possible to apply a miniaturized semiconductor process with a lower voltage, and thus it is possible to reduce the size of the semiconductor storage device.

Note that, in the above description, one of the signal line L215 and each of the signal lines L216 and L217 is connected to the ground GND to perform control so that a voltage equal to or higher than a predetermined voltage is applied to each MTJ element M210. That is, in the above-described example, a connection destination of each signal line is controlled so that a voltage equal to or higher than a predetermined voltage is applied to each MTJ element M210 with the ground GND as a reference potential. Meanwhile, if it is possible to control the potentials of the signal line L215 and each of the signal lines L216 and L217 so that a voltage equal to or higher than a predetermined voltage is applied to each MTJ element M210, the connection destination of each signal line is not necessarily limited to the above-described example. Furthermore, a voltage applied to the MTJ elements M210 (that is, the voltage equal to or higher than a predetermined voltage described above) in order to cause the states of the MTJ elements M210 to transition when data is written corresponds to an example of a “first voltage”. On the other hand, a voltage applied to the MTJ elements M210 when data is read to the extent that the states of the MTJ elements M210 do not transition corresponds to an example of a “second voltage”.

(Control Relating to Reading of Data)

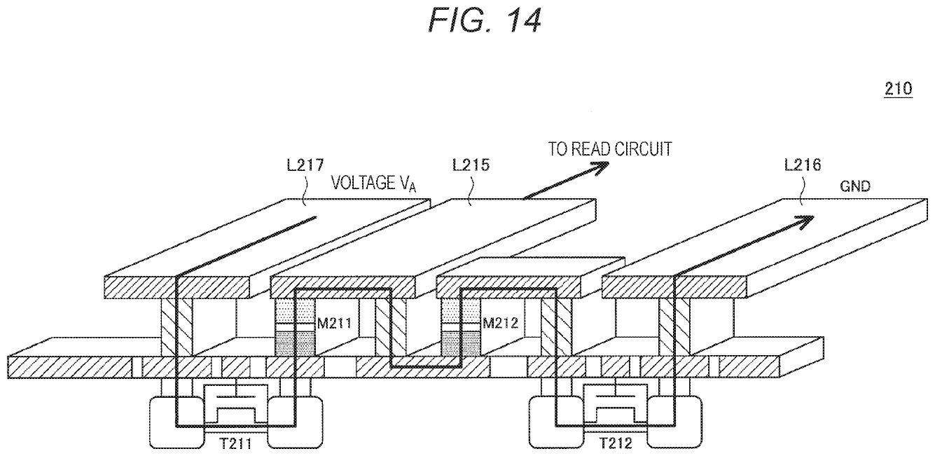

Next, an example of control relating to reading of data in the semiconductor storage device 210 according to the present embodiment will be described with reference to FIG. 14. FIG. 14 is an explanatory diagram for describing an example of the control of the semiconductor storage device 210 according to the present embodiment, and illustrates an example of control relating to reading of data according to the states of the MTJ elements M210. Furthermore, FIG. 14 also illustrates an example of a schematic configuration in a case where a memory cell of the semiconductor storage device 210 illustrated in FIG. 11 is implemented by a so-called laminated structure.

When data is read, for example, the signal line L217 is connected to a power supply voltage V_{B}, and the signal line L216 is connected to the ground GND. Note that V_{A}>V_{B}>GND. Next, when the MTJ elements M211 and M212 are selected by the selection transistors T211 and T212 controlled to be in the on-state, a voltage according to a potential difference between the signal lines L217 and L216 is applied to the MTJ elements M211 and M212. That is, a current flows from the signal line L217 to the signal line L216 via the MTJ element M211, the signal line L215, and the MTJ element M212. Note that the voltage V_{B} is set so that a current flows to each of the MTJ elements M211 and M212 to the extent that the respective states of the MTJ elements M211 and M212 do not transition. Furthermore, the signal line L215 is connected to the node (node N211 illustrated in FIG. 11) connected to the read circuit. As a result, a signal according to the potential of the signal line L215 is amplified by a sense amplifier and output as a read signal to the read circuit.

Note that a level of the read signal (in other words, the potential of the signal line L215) is relatively determined in accordance with the respective states of the MTJ elements M211 and M212. That is, the read circuit can determine whether the read data corresponds to the H data or the L data in accordance with the level of the read signal.

Furthermore, in the above description, one of the signal lines L216 and L217 is connected to the ground GND to perform control so that a voltage is applied to each MTJ element M210 to the extent that the states of the MTJ elements M210 do not transition. Meanwhile, if it is possible to control the potentials of the signal lines L216 and L217 so that a voltage is applied to each MTJ element M210 to the extent that the states of the MTJ elements M210 do not transition, the connection destination of each signal line is not necessarily limited to the above-described example. Furthermore, in the above description, the description has been made assuming that a state of the memory cell according to the control illustrated in FIG. 12 is associated with the H data, and a state of the memory cell according to the control illustrated in FIG. 13 is associated with the L data. Meanwhile, the association between each state according to the control illustrated in FIGS. 12 and 13 and data (for example, H data and L data) is not necessarily limited to only the above-described example. That is, the state of the memory cell according to the control illustrated in FIG. 12 may be associated with the L data, and the state of the memory cell according to the control illustrated in FIG. 13 may be associated with the H data.

The example of the control of the semiconductor storage device according to the present embodiment has been described above with reference to FIGS. 12 to 14, focusing particularly on the control relating to each of writing of data and reading of data.

<5.3. Data Abnormality Detection>

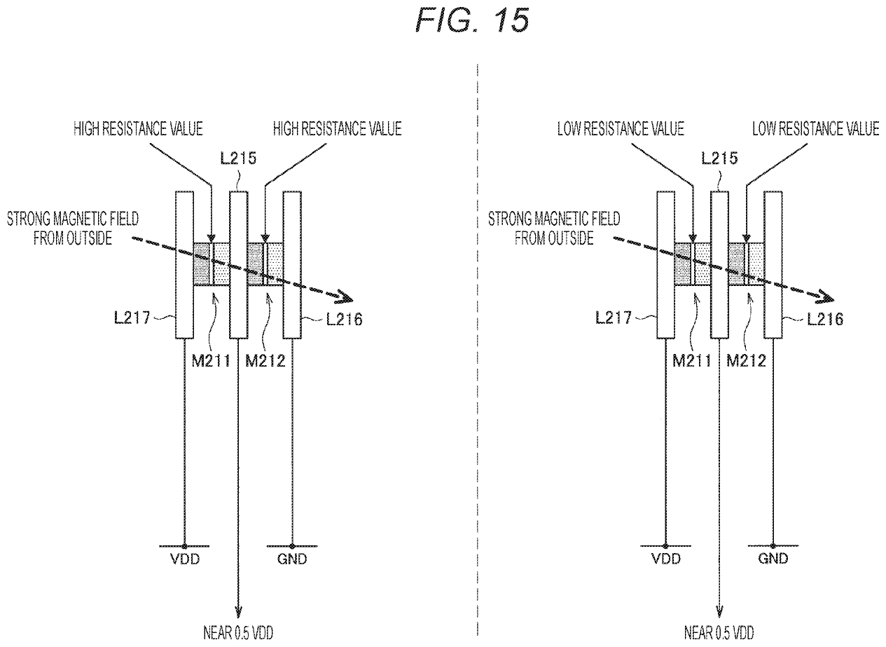

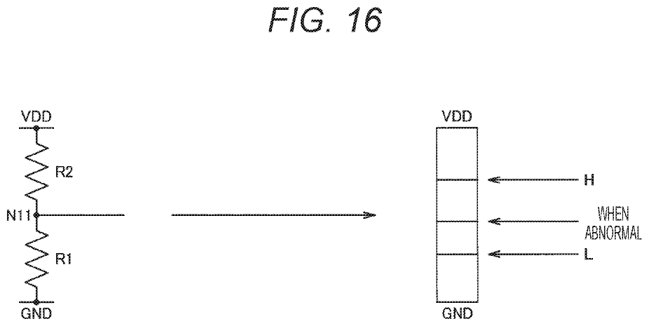

The semiconductor storage device according to the present embodiment can detect, in accordance with a level of a read signal, that data held in a memory cell (in other words, data held in a storage element such as an MTJ element) has been rewritten in a case where the data has been unintentionally or illegally rewritten due to influence of an external factor such as a strong magnetic field from the outside. Therefore, a mechanism for detecting that data has been rewritten in a case where the data has been rewritten due to an external factor will be described below with reference to FIGS. 15 and 16. FIGS. 15 and 16 are explanatory diagrams for describing an example of the mechanism for detecting that data has been rewritten due to an external factor in the semiconductor storage device according to the present embodiment.

For example, FIG. 15 illustrates an example in which states of MTJ elements constituting a memory cell transition due to influence of a strong magnetic field from the outside. As described above, in the storage device according to the present embodiment, when data is written, a state of at least a part of a plurality of storage elements constituting one memory cell is controlled to transition to a state different that of from another storage element. That is, in the case of the semiconductor storage device 210 illustrated in FIG. 11, for example, one of the MTJ elements M211 and M212 constituting one memory cell is controlled to be in the parallel state, and the other is controlled to be in the antiparallel state. In other words, in a case where one memory cell includes two MTJ elements M210 as in the semiconductor storage device 210 illustrated in FIG. 11, respective states of the two MTJ elements M210 have a complementary relationship in a case where data is normally written.

Meanwhile, as illustrated in FIG. 15, when each of the plurality of MTJ elements constituting one memory cell is exposed to a strong magnetic field from the outside, a similar magnetic field is applied to each of the plurality of MTJ elements. Therefore, in this case, each of the plurality of MTJ elements constituting one memory cell transitions to the same state.

For example, a diagram illustrated on the left side of FIG. 15 illustrates an example in which the respective states of the MTJ elements M211 and M212 constituting one memory cell are the antiparallel states due to the influence of a strong magnetic field from the outside. In this case, both the MTJ elements M211 and M212 exhibit higher resistance values. That is, since the MTJ elements M211 and M212 exhibit resistance values substantially equal to each other, the potential of the signal line L215 is a potential near the middle between the potential of the signal line L217 and the potential of the signal line L216.

Furthermore, a diagram illustrated on the right side of FIG. 15 illustrates an example in which the respective states of the MTJ elements M211 and M212 constituting one memory cell are the parallel states due to the influence of a strong magnetic field from the outside. In this case, both the MTJ elements M211 and M212 exhibit lower resistance values. That is, also in this case, since the MTJ elements M211 and M212 exhibit resistance values substantially equal to each other, the potential of the signal line L215 is a potential near the middle between the potential of the signal line L217 and the potential of the signal line L216.

Next, an example of a mechanism for detecting, in accordance with a level of a read signal output via the signal line L215, that data has been rewritten due to an external factor such as a strong magnetic field from the outside will be described with reference to FIG. 16.

A diagram on the left side of FIG. 16 illustrates a schematic equivalent circuit of one memory cell in a case where two MTJ elements M210 (for example, MTJ elements M211 and M212) constituting one memory cell are regarded as resistors, in the semiconductor storage device 210 described with reference to FIG. 11. Specifically, in the diagram on the left side of FIG. 16, resistors R1 and R2 schematically indicate two MTJ elements M210 constituting the memory cell. That is, each of the resistors R1 and R2 exhibits one of a higher resistance value and a lower resistance value depending on whether a state of corresponding one of the MTJ elements M210 is the parallel state or the antiparallel state. Note that the read signal is read from a node between the resistors R1 and R2, which is indicated by a reference numeral N11. Furthermore, a potential of the node N11 is determined in accordance with the respective resistance values of the resistors R1 and R2.

On the basis of such a configuration, in a case where data has been normally written to the memory cell, the MTJ elements M210 corresponding to the resistors R1 and R2 transition to states different from each other, and thus the resistors R1 and R2 indicate resistance values different from each other. Therefore, for example, in a case where the resistor R1 exhibits a higher resistance value and the resistor R2 exhibits a lower resistance value, the potential of the node N11 is higher than the intermediate potential between a power supply voltage VDD and the ground GND. Note that the node N11 corresponds to the signal line L215 in the example illustrated in FIG. 11, for example. As a more specific example, in the case of the example illustrated in FIG. 11, the potential of the signal line L215 is higher than the intermediate potential between the signal lines L216 and L217. In this case, the level of the read signal exhibits a value higher than the level corresponding to half the voltage applied between the power supply voltage VDD and the ground GND. For example, in the example illustrated in FIG. 16, the level of the read signal in this case is associated with the “H data”.

On the other hand, in a case where the resistor R1 exhibits a lower resistance value and the resistor R2 exhibits a higher resistance value, the potential of the node N11 is lower than the intermediate potential between the power supply voltage VDD and the ground GND. As a more specific example, in the case of the example illustrated in FIG. 11, the potential of the signal line L215 is lower than the intermediate potential between the signal lines L216 and L217. In this case, the level of the read signal exhibits a value lower than a level corresponding to half the voltage applied between the power supply voltage VDD and the ground GND. For example, in the example illustrated in FIG. 16, the level of the read signal in this case is associated with the “L data”.

On the other hand, as illustrated in FIG. 15, in a case where the states of the MTJ elements M210 transition due to an external factor, the MTJ elements M210 corresponding to the resistors R1 and R2 transition to the same states, and thus the resistor R1 and R2 exhibit the same resistance values. Note that the potential of the node N11 is a potential near the middle between the power supply voltage VDD and the ground GND in both the cases where both the resistors R1 and R2 exhibit higher resistance values and where both the resistors R1 and R2 exhibit lower resistance values. As a more specific example, in the case of the example illustrated in FIG. 11, the potential of the signal line L215 is substantially equal to the intermediate potential between the signal lines L216 and L217. In this case, the level of the read signal exhibits a value substantially equal to the level corresponding to half the voltage applied between the power supply voltage VDD and the ground GND.

As described above, in the semiconductor storage device according to the present embodiment, even in a case where data has been rewritten due to an external factor such as a strong magnetic field from the outside, it is possible to detect, in accordance with the level of the read signal, that the data has been rewritten. Furthermore, the level of the read signal in this case is relatively determined in accordance with the respective states of the MTJ elements M210 corresponding to the resistors R1 and R2. Therefore, influence of variations between elements referred to at the time of reading (for example, element variations of the MTJ elements M210) is further reduced in the level of the read signal (ideally, the influence of the variations is eliminated). Note that, in a case where the potential of the node N11 is higher or lower than the intermediate potential between the power supply voltage VDD and the ground GND, the association between the level of the read signal and data (that is, the H data and the L data) may be opposite to that in the above-described example. That is, the case where the potential of the node N11 is higher than the intermediate potential between the power supply voltage VDD and the ground GND may correspond to the L data, and the case where the potential of the node N11 is lower than the intermediate potential may correspond to the H data.

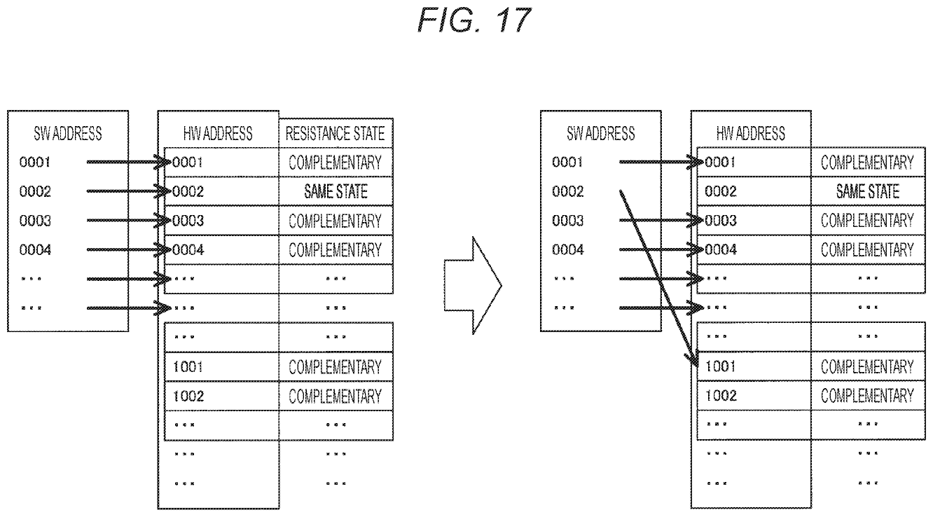

Next, an example of control of the semiconductor storage device according to the present embodiment in a case where it is detected that data in a part of memory cells has been rewritten due to an external factor will be described with reference to FIG. 17. FIG. 17 is an explanatory diagram for describing an example of the control in a case where it is detected that data has been rewritten due to an external factor in the semiconductor storage device according to the present embodiment. Note that, in the example illustrated in FIG. 17, two MTJ elements constitute one memory cell.

The semiconductor storage device according to the present embodiment assigns a memory cell (that is, a plurality of storage elements constituting the memory cell) to each bit that is the minimum unit of data. Specifically, an address associated with a bit (software address) and an address associated with a memory cell (in other words, the plurality of storage elements constituting the memory cell) (hardware address) are associated with each other. Thus, the memory cell is assigned to the bit. On the basis of such a configuration, in a case where it is detected that data in a memory cell assigned to a part of bits has been rewritten due to an external factor, the semiconductor storage device according to the present embodiment may reassign another memory cell (for example, a spare memory cell) to the part of bits.

For example, an example illustrated on the left side of FIG. 17 illustrates an example of association between software addresses associated with bits and hardware addresses associated with memory cells. Furthermore, in the example illustrated in FIG. 17, a state of a memory cell associated with a hardware address, that is, a state indicating whether or not data of the memory cell has been rewritten is shown as a “resistance state”. Note that a state shown as “complementary” corresponds to a case where two MTJ elements constituting a memory cell exhibit states different from each other, that is, a state in which data has been normally written. Furthermore, a state shown as “same state” corresponds to a case where two MTJ elements constituting a memory cell exhibit the same states, that is, a state in which data has been rewritten due to an external factor.

More specifically, in the diagram on the left side of FIG. 17, hardware addresses “0001” to “0004” are associated with software addresses “0001” to “0004”, respectively. On the basis of such a configuration, in the diagram on the left side of FIG. 17, a resistance state of a memory cell associated with the hardware address “0002” is “same state”. That is, in the example illustrated in FIG. 17, data in the memory cell associated with the hardware address “0002” has been rewritten due to an external factor.

In this case, the semiconductor storage device (read circuit 107) detects, in accordance with a read signal from the memory cell associated with the hardware address “0002”, that the data in the memory cell has been rewritten due to an external factor. Therefore, in the example illustrated in FIG. 17, as illustrated in a diagram on the right side, the semiconductor storage device (control circuit 105) associates again, with the software address “0002”, another hardware address “1001” associated with a normal memory cell (for example, a spare memory cell), in place of the hardware address “0002”.

By the control as described above, it is possible to prevent occurrence of a situation where a memory cell (in other words, a storage element) in which data has been rewritten due to an external factor is referred to, that is, a situation where the rewritten data is used.

Each of the mechanism for detecting that data held in a memory cell has been rewritten due to influence of an external factor and the mechanism for performing control so that the memory cell in which the data has been rewritten is not referred to has been described above with reference to FIGS. 15 to 17.

<5.4. Modification>

Next, a modification of the semiconductor storage device according to the present embodiment will be described.

As described above, the semiconductor storage device according to the present embodiment performs control so that a state of at least a part of a plurality of storage elements constituting one memory cell transitions to a state different from that of another storage element when data is written. Furthermore, at this time, the semiconductor storage device according to the present embodiment performs control so that at least two or more storage elements among the plurality of storage elements constituting one memory cell are connected in parallel, and then performs control so that a voltage of a certain level or more is applied to each of the two or more storage elements (that is, performs control so that a current of a certain level or more flows). On the basis of such a configuration, the semiconductor storage device according to the present embodiment determines, in accordance with a level of a read signal from each memory cell, whether or not data held in the memory cell has been rewritten due to an external factor when data is read.

Meanwhile, the configuration of the semiconductor storage device according to the present embodiment (in particular, the configuration near a memory cell) is not particularly limited as long as the configuration described above can be implemented. Therefore, as a modification of the semiconductor storage device according to the present embodiment, another example of the configuration of the semiconductor storage device will be described below.

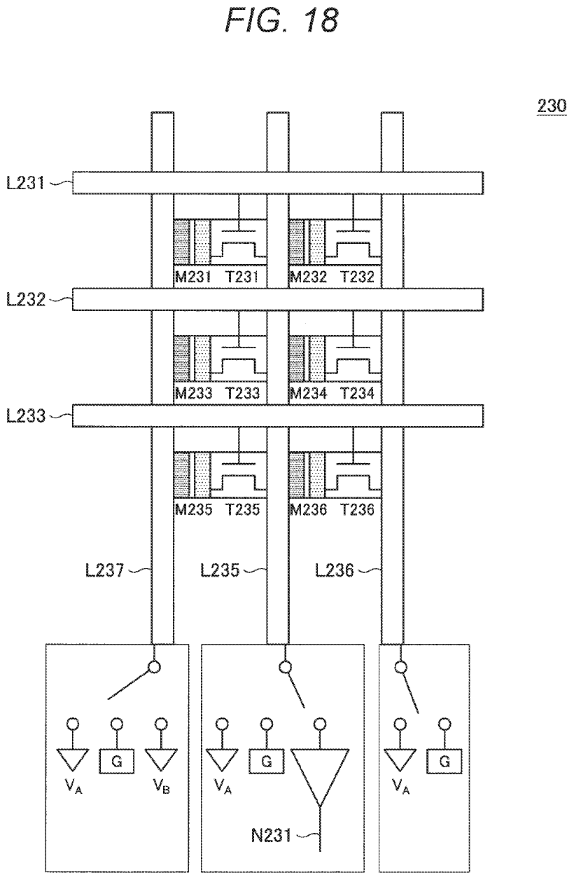

For example, FIG. 18 is an explanatory diagram for describing an example of a schematic configuration of a semiconductor storage device according to the modification, and schematically illustrates an example of an electrical connection relationship near a memory cell.

A semiconductor storage device 230 illustrated in FIG. 18 is a semiconductor storage device having the 2T-2MTJ configuration in which one memory cell includes two MOS transistors and two MTJ elements, similarly to the semiconductor storage device 210 described above with reference to FIG. 11. In FIG. 18, each of reference numerals M231 to M236 indicates an MTJ element. Furthermore, each of reference numerals T231 to T236 indicates a selection transistor. Note that, in the following description, the MTJ elements M231 to M236 may be referred to as “MTJ elements M230” in a case where the MTJ elements M231 to M236 are not particularly distinguished. Furthermore, the selection transistors T231 to T236 may be referred to as “selection transistors T230” in a case where the selection transistors T231 to T236 are not particularly distinguished.

As illustrated in FIG. 18, the semiconductor storage device 230 is different from the semiconductor storage device 210 described with reference to FIG. 11 in a connection relationship of a part of elements constituting one memory cell. Specifically, the MTJ elements M231 to M236 correspond to the MTJ elements M211 to M216 in the example illustrated in FIG. 11. Furthermore, the selection transistors T231 to T236 correspond to the selection transistors T211 to T216 in the example illustrated in FIG. 11. Furthermore, signal lines L231 to L237 correspond to the signal lines L211 to L217 in the example illustrated in FIG. 11.

That is, the semiconductor storage device 230 illustrated in FIG. 18 is different from the semiconductor storage device 210 illustrated in FIG. 11 in a positional relationship between the MTJ elements M231, M233, and M235 and the selection transistors T231, T233, and T235, respectively. As a specific example, focusing on a relationship between the MTJ element M231 and the selection transistor T231, in the semiconductor storage device 230, the selection transistor T231 is arranged so as to be interposed between the MTJ element M231 and the signal line L235. On the other hand, in the semiconductor storage device 210 illustrated in FIG. 11, the selection transistor T211 is arranged so as to be interposed between the MTJ element M211 and the signal line L217. The same applies to a relationship between the MTJ element M233 and the selection transistor T233 and a relationship between the MTJ element M235 and the selection transistor T235. Furthermore, in the example illustrated in FIG. 18, the signal line L235 corresponds to an example of the “first signal line”, and each of the signal lines L236 and L237 corresponds to an example of the “second signal line”.

Next, an example of control of the semiconductor storage device according to the modification will be described, focusing particularly on control relating to each of writing of data and reading of data.

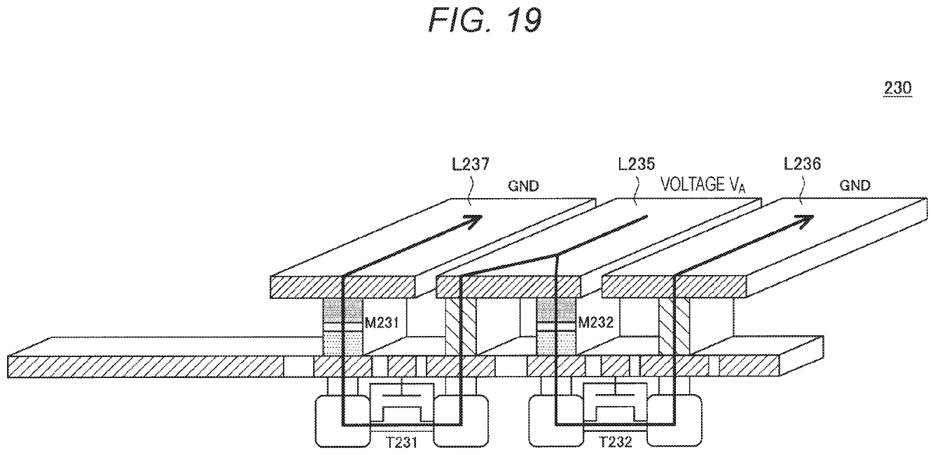

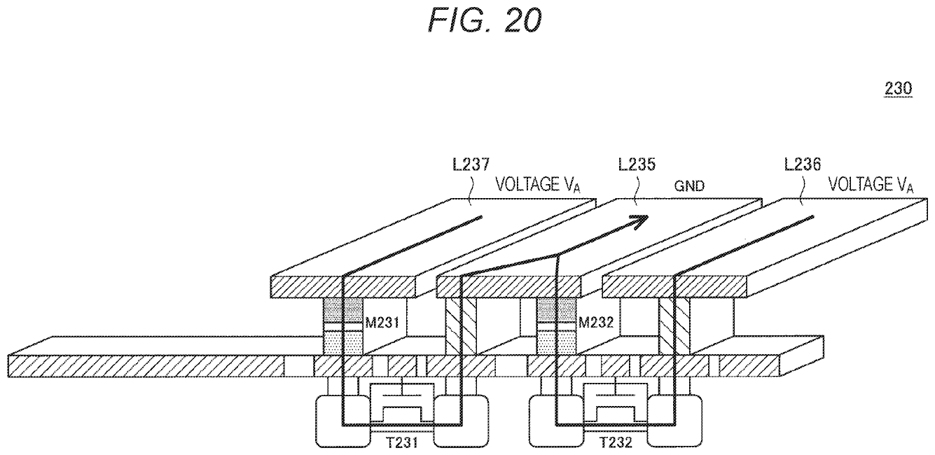

First, an example of control relating to writing of data in the semiconductor storage device 230 according to the modification will be described with reference to FIGS. 19 and 20. FIGS. 19 and 20 are explanatory diagrams for describing an example of control of the semiconductor storage device 230 according to the modification, and illustrate an example of control relating to voltage application to the MTJ elements M230 when data is written. Note that, in the following description, for convenience, FIG. 19 illustrates an example of writing H data to a memory cell, and FIG. 13 illustrates an example of writing L data to a memory cell. Furthermore, FIGS. 12 and 13 also illustrate an example of a schematic configuration in a case where a memory cell of the semiconductor storage device 230 illustrated in FIG. 11 is implemented by a so-called laminated structure.

First, an example of control in a case where the H data is written to a memory cell will be described with reference to FIG. 19. In this case, for example, the signal line L235 is connected to a power supply voltage V_{A} and each of the signal lines L236 and L237 is connected to a ground GND. Note that V_{A}>GND. Next, when the MTJ elements M231 and M232 are selected by the selection transistors T231 and T232 controlled to be in the on-state, a voltage according to a potential difference between the signal line L235 and each of the signal lines L237 and L236 is applied to each of the MTJ elements M231 and M232. At this time, the MTJ elements M231 and M232 are connected in parallel, and a current flows from the signal line L235 to each of the signal lines L237 and L236 via corresponding one of the MTJ elements M230 and corresponding one of the selection transistors T230. Specifically, a current according to a potential difference between the signal line L235 and the signal line L237 flows from the signal line L235 to the signal line L237 via the selection transistor T231 and the MTJ element M231. Furthermore, a current according to a potential difference between the signal line L235 and the signal line L236 flows from the signal line L235 to the signal line L236 via the MTJ element M232 and the selection transistor T232. At this time, in a case where the voltage applied to each of the MTJ elements M231 and M232 is equal to or higher than a predetermined voltage, a current of a certain level or more flows through the MTJ elements M231 and M232. As a result, respective states of the MTJ elements M231 and M232 transition to a parallel state or an antiparallel state in accordance with a direction in which the current flows (that is, a direction in which the voltage is applied). Specifically, in the case of the example illustrated in FIG. 19, the MTJ element M231 transitions to the antiparallel state and has a lower resistance value, and the MTJ element M232 transitions to the parallel state and has a higher resistance value.

Next, an example of control in a case where the L data is written to a memory cell will be described with reference to FIG. 20. In this case, for example, the signal line L235 is connected to the ground GND and each of the signal lines L236 and L237 is connected to the power supply voltage V_{A}. Next, when the MTJ elements M231 and M232 are selected by the selection transistors T231 and T232 controlled to be in the on-state, a voltage according to a potential difference between each of the signal lines L237 and L236 and the signal line L235 is applied to each of the MTJ elements M231 and M232. At this time, the MTJ elements M231 and M232 are connected in parallel, and a current flows from each of the signal lines L237 and L236 to the signal line L235 via corresponding one of the MTJ elements M230 and corresponding one of the selection transistors T230. Specifically, a current according to a potential difference between the signal line L237 and the signal line L235 flows from the signal line L237 to the signal line L235 via the MTJ element M231 and the selection transistor T231. Similarly, a current according to a potential difference between the signal line L236 and the signal line L235 flows from the signal line L236 to the signal line L235 via the selection transistor T232 and the MTJ element M232. At this time, in a case where the voltage applied to each of the MTJ elements M231 and M232 is equal to or higher than a predetermined voltage, a current of a certain level or more flows through the MTJ elements M231 and M232. As a result, the respective states of the MTJ elements M231 and M232 transition to the parallel state or the antiparallel state in accordance with a direction in which the current flows (that is, a direction in which the voltage is applied). Specifically, in the case of the example illustrated in FIG. 20, the MTJ element M231 transitions to the parallel state and has a higher resistance value, and the MTJ element M232 transitions to the antiparallel state and has a lower resistance value.

As described above, in the semiconductor storage device 230 illustrated in FIG. 18, when data is written, two MTJ elements M230 constituting one memory cell are controlled to be in states different from each other. That is, in the semiconductor storage device according to the modification, as in the semiconductor storage device according to the above-described embodiment, when data is written, control is performed so that a state of at least a part of a plurality of storage elements constituting one memory cell transitions to a state different from that of another storage element. Furthermore, with such a configuration, in the semiconductor storage device according to the modification, as in the semiconductor storage device according to the above-described embodiment, it is possible to detect that data held in the MTJ elements M230 has been rewritten even in a case where the data has been unintentionally or illegally rewritten due to an external factor such as a strong magnetic field from the outside.

Furthermore, in the semiconductor storage device 230 illustrated in FIG. 18, as in the semiconductor storage device 210 illustrated in FIG. 11, when data is written, an electrical connection relationship between two MTJ elements M230 constituting one memory cell is controlled so that the elements constituting the memory cell are in parallel. Therefore, the semiconductor storage device 230 according to the modification can further reduce a voltage applied to each MTJ element M230 when data is written, as compared with the semiconductor storage device 130 according to the second comparative example described above (see FIGS. 7 to 10). That is, the semiconductor storage device 230 according to the modification can further reduce power consumption as compared with the semiconductor storage device 130 according to the second comparative example.

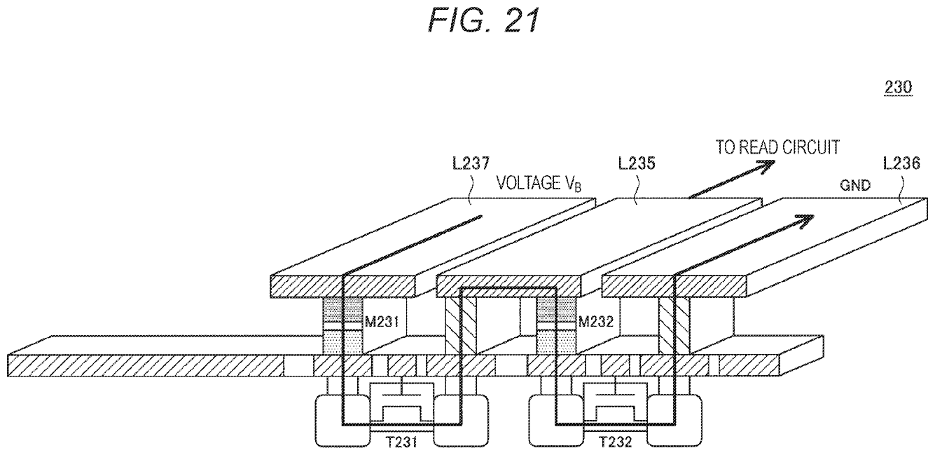

Next, an example of control relating to reading of data in the semiconductor storage device 230 according to the modification will be described with reference to FIG. 21. FIG. 21 is an explanatory diagram for describing an example of the control of the semiconductor storage device 230 according to the modification, and illustrates an example of control relating to reading of data according to the states of the MTJ elements M230. Furthermore, FIG. 21 also illustrates an example of a schematic configuration in a case where a memory cell of the semiconductor storage device 230 illustrated in FIG. 18 is implemented by a so-called laminated structure.

When data is read, the signal line L237 is connected to a power supply voltage V_{B}, and the signal line L236 is connected to the ground GND. Note that V_{A}>V_{B}>GND. Next, when the MTJ elements M231 and M232 are selected by the selection transistors T231 and T232 controlled to be in the on-state, a voltage according to a potential difference between the signal lines L237 and L236 is applied to the MTJ elements M231 and M232. That is, a current flows from the signal line L237 to the signal line L236 via the MTJ element M231, the signal line L235, and the MTJ element M232. Note that the voltage V_{B} is set so that a current flows to each of the MTJ elements M231 and M232 to the extent that the respective states of the MTJ elements M231 and M232 do not transition. Furthermore, the signal line L235 is connected to a node (node N231 illustrated in FIG. 18) connected to the read circuit. As a result, a signal according to a potential of the signal line L235 is amplified by a sense amplifier and output as a read signal to the read circuit.

Note that a level of the read signal is relatively determined in accordance with the respective states of the MTJ elements M231 and M232, as in the semiconductor storage device 210 illustrated in FIG. 11. That is, the read circuit can determine whether the read data corresponds to the H data or the L data in accordance with the level of the read signal.

Furthermore, also in the semiconductor storage device 230 according to the modification, as described with reference to FIG. 15, when each of a plurality of MTJ elements constituting one memory cell is exposed to a strong magnetic field from the outside, a similar magnetic field is applied to each of the plurality of MTJ elements. Therefore, in the semiconductor storage device 230 according to the modification, even in a case where data held in a memory cell has been rewritten due to an external factor, it is possible to detect, in accordance with the level of the read signal, that the data has been rewritten, as in the semiconductor storage device 210 according to the above-described embodiment.

The example of the configuration and control of the semiconductor storage device according to the modification has been described above with reference to FIGS. 18 to 21.

<5.5. Supplement>

Note that, in the above description, the configuration of the semiconductor storage device according to the embodiment of the present disclosure has been described focusing on the case where the configuration of a memory cell is the 2T-2MTJ configuration, but the configuration of the semiconductor storage device is not necessarily limited. As a specific example, in the semiconductor storage device, one memory cell may include three or more storage elements. In other words, the semiconductor storage device may have an nT-nMTJ configuration (n≥2). Note that, in this case, when data is written to each memory cell, the semiconductor storage device performs control so that a state of a part of the three or more storage elements constituting the memory cell is different from a state of another storage element. Furthermore, in a case where each of the three or more storage elements constituting the memory cell is in the same state when data is read, the semiconductor storage device is only required to recognize that data held in the memory cell has been rewritten due to influence of an external factor. Furthermore, it is also possible to configure one memory cell by associating a plurality of circuit groups each having the 2T-2MTJ configuration described above. As a specific example, a memory cell having a 4T-4MTJ configuration may be implemented by combining two circuit groups each having the 2T-2MTJ configuration.

Furthermore, in the above-described example, the example in which a magnetoresistive effect element such as an MTJ element is applied as a storage element has been described, but an element applicable as the storage element 101 is not limited. As a specific example, the storage element 101 is not limited to an element that can take two states such as an MTJ element as long as an element transitions to any of a plurality of states in accordance with an applied voltage, and it is also possible to apply, as the storage element 101, an element that can take three or more states. Even in this case, the semiconductor storage device is only required to perform control so that a state of a part of a plurality of storage elements constituting one memory cell is different from a state of another storage element. Furthermore, in a case where data has been rewritten due to influence of an external factor, it is presumed that all of the plurality of storage elements constituting one memory cell transition to the same states. Therefore, in a case where each of the plurality of storage elements constituting the memory cell is in the same state when data is read, the semiconductor storage device is only required to recognize that data held in the memory cell has been rewritten due to influence of an external factor.

### 6. APPLICATION EXAMPLE

Next, as an application example of the semiconductor storage device according to the embodiment of the present disclosure, an example of an electronic apparatus to which the semiconductor storage device is applied will be described.

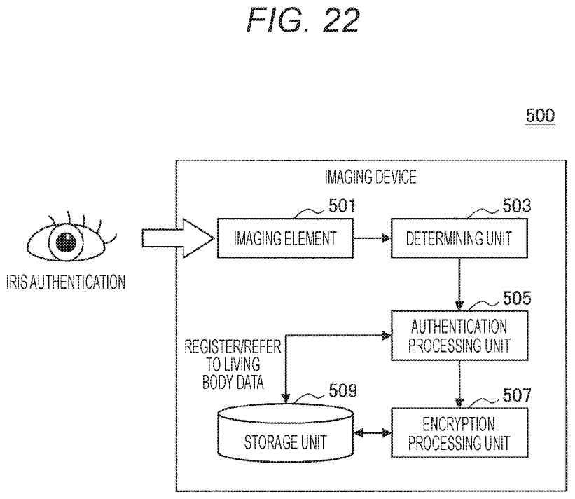

For example, FIG. 22 is an explanatory diagram for describing the application example of the semiconductor storage device according to the embodiment of the present disclosure, and illustrates an example of a functional configuration of an electronic apparatus using the semiconductor storage device as a data storage area. Specifically, FIG. 22 is a block diagram illustrating an example of a functional configuration of an imaging device used for iris authentication.

As illustrated in FIG. 22, an imaging device 500 includes an imaging element 501, a determining unit 503, an authentication processing unit 505, an encryption processing unit 507, and a storage unit 509.

The imaging element 501 captures an image of a subject within an imaging range and outputs the image (hereinafter, also referred to as “captured image”) to the determining unit 503 located in a subsequent stage. Note that, in a case where an eyeball of a desired user is located within the imaging range of the imaging element 501, the eyeball (and thus an iris in the eyeball) is captured as the subject in the captured image.

The determining unit 503 determines whether or not the subject is a living body on the basis of components of the subject in the captured image. As a more specific example, the determining unit 503 may perform image analysis on the captured image to extract characteristics of the subject in the captured image, and determine, on the basis of an extraction result of the characteristics, whether or not the iris is captured as the subject in the captured image. Then, in a case where the determining unit 503 determines that the living body (iris) is captured in the captured image, the authentication processing unit 505 located in the subsequent stage executes authentication processing based on the captured image.

The authentication processing unit 505 performs authentication by comparing the iris captured as the subject in the captured image with information on an iris pattern registered in advance. Note that the iris pattern is held in the storage unit 509, for example. Furthermore, in a case where it is recognized that an iris pattern of the captured iris is not registered as a result of the comparison, the authentication processing unit 505 may generate an iris pattern on the basis of the iris captured as the subject in the captured image and register the iris pattern in the storage unit 509. Furthermore, the authentication processing unit 505 may output an authentication result to a predetermined output destination. For example, in the example illustrated in FIG. 22, the authentication processing unit 505 outputs the authentication result to the encryption processing unit 507.

The encryption processing unit 507 encrypts various types of information and generates various types of information (for example, key information, signature information, and the like) for the encryption. In the example illustrated in FIG. 22, the encryption processing unit 507 may encrypt various types of information and generate various types of information for the encryption on the basis of the authentication result by the authentication processing unit 505, for example.

The storage unit 509 temporarily or permanently holds various types of information for each component in the imaging device 500 to execute various types of processing. Furthermore, the storage unit 509 may hold information on an iris pattern used for the above-described authentication processing. The storage unit 509 may include, for example, a non-volatile recording medium (for example, an MRAM or the like) capable of holding stored contents without power supply. As a specific example, as the storage unit 509, for example, the semiconductor storage device according to the embodiment of the present disclosure described above may be applied. With this arrangement, even in a case where information held in the storage unit 509 has been rewritten due to an external factor such as a strong magnetic field from the outside, it is possible to perform control so that it is detected that the information has been rewritten and the rewritten information (for example, information on an iris pattern) is not used.

Note that the above-described example is merely an example, and does not necessarily limit an application destination of the semiconductor storage device according to the embodiment of the present disclosure. That is, as long as an electronic apparatus temporarily or permanently holds various types of information, the semiconductor storage device according to the embodiment of the present disclosure can be applied as a storage device for holding the information. Examples of such an electronic apparatus include an information processing device, a moving body, a robot, and the like. More specifically, examples of the information processing device include a PC, a tablet, a smartphone, and the like. Furthermore, examples of the moving body include a vehicle, a drone, and the like. In addition, examples of the robot include an autonomous robot, an industrial robot, and the like. In particular, an electronic apparatus that requires higher security for recording information has a high affinity with the semiconductor storage device according to the embodiment of the present disclosure. That is, if the semiconductor storage device according to the embodiment of the present disclosure is applied to such an electronic apparatus, for example, it is possible to prevent occurrence of a situation where information or data that has been tampered with illegally due to influence of an external factor is used, and thus prevent unauthorized access or the like.

As the application example of the semiconductor storage device according to the embodiment of the present disclosure, the example of the electronic apparatus to which the semiconductor storage device is applied has been described above.

### 7. CONCLUSION

As described above, the semiconductor storage device according to the embodiment of the present disclosure includes a plurality of elements each of which transitions to any of a plurality of states in accordance with an applied voltage, a control unit, and a determination unit. The control unit assigns, as one bit, at least two or more elements included in the plurality of elements and controls, for each bit, application of a voltage to each of the two or more elements corresponding to the bit. Furthermore, the determination unit determines that the bit is normal in a case where a state of a part of the two or more elements assigned as the bit is different from a state of another element, and determines that the bit is abnormal in a case where respective states of the two or more elements are the same. In addition, the control unit may perform control so that a state of a part of the two or more elements corresponding to the bit is a state different from that of another element when data is written to the bit. Furthermore, the control unit may assign, to the bit determined to be abnormal, other two or more elements different from the two or more elements assigned to the bit.

With the above configuration, the semiconductor storage device according to the embodiment of the present disclosure can detect that information held in a storage element has been rewritten even in a case where the information has been unintentionally or illegally rewritten due to influence of an external factor. Furthermore, the semiconductor storage device can also prevent a situation where the storage element in which the information has been rewritten is used (that is, a situation where the rewritten information is used) by reassigning, on the basis of a result of the detection, another storage element to a bit to which the storage element in which the information has been rewritten is assigned.

The preferred embodiment of the present disclosure has been described above in detail with reference to the accompanying drawings, but the technical scope of the present disclosure is not limited to such examples. It is obvious that those having ordinary knowledge in the technical field of the present disclosure can conceive various changes or modifications within the scope of the technical idea described in the claims, and of course, it is understood that these changes and modifications also belong to the technical scope of the present disclosure.

Furthermore, the effects described in the present specification are merely illustrative or exemplary, and are not restrictive. That is, the technology according to the present disclosure can exhibit other effects that are obvious to those skilled in the art from the description in the present specification, in addition to or instead of the above effects.

Note that the following configurations also belong to the technical scope of the present disclosure.

(1)

A semiconductor storage device including

a plurality of storage elements each of which transitions to any of a plurality of states in accordance with an applied voltage,

a control unit that assigns, as one bit, at least two or more storage elements included in the plurality of storage elements and controls, for each bit, application of a voltage to each of the two or more storage elements corresponding to the bit, and

a determination unit that determines that the bit is normal in a case where a state of a part of the two or more storage elements assigned as the bit is different from a state of another storage element, and determines that the bit is abnormal in a case where respective states of the two or more storage elements are same.

(2)

The semiconductor storage device according to (1), in which the control unit assigns, to the bit determined to be abnormal, other two or more storage elements different from the two or more storage elements assigned to the bit.

(3)

The semiconductor storage device according to (2), in which the control unit assigns the two or more storage elements to the bit by associating a hardware address of each of the two or more storage elements with a software address set for each bit.

(4)

The semiconductor storage device according to any one of (1) to (3), in which the control unit performs control so that a state of a part of the two or more storage elements corresponding to the bit is a state different from another storage element when data is written to the bit.

(5)

The semiconductor storage device according to any one of (1) to (4) in which

the storage elements are storage elements that transition to states different from each other in accordance with a direction in which the voltage is applied, and

the control unit performs control so that the voltage is applied in different directions to each of at least two storage elements of the two or more storage elements corresponding to the bit when data is written to the bit.

(6)

The semiconductor storage device according to (5), in which

the control unit

performs control so that the at least two storage elements of the two or more storage elements corresponding to the bit are connected in parallel when data is written to the bit, and

performs control so that the at least two storage elements of the two or more storage elements corresponding to the bit are connected in series when data is read from the bit.

(7)

The semiconductor storage device according to (6), in which

the control unit

assigns two storage elements included in the plurality of storage elements as the bit,

performs control so that the two storage elements corresponding to the bit are connected in parallel when data is written to the bit, and

performs control so that the two storage elements corresponding to the bit are connected in series when data is read from the bit.

(8)

The semiconductor storage device according to (7), in which

the storage elements are storage elements whose states transition in a case where a voltage higher than a threshold value is applied,

the semiconductor storage device further includes

a first signal line commonly connected to the two storage elements, and

two second signal lines each individually connected to corresponding one of the two storage elements,

the control unit

controls a potential difference between the first signal line and each of the two second signal lines so that a first voltage higher than the threshold value is applied to each of the two storage elements when data is written to the bit, and

controls a potential difference between the two second signal lines so that a second voltage lower than the threshold value is applied to each of the two storage elements when data is read from the bit, and

data corresponding to a potential of the first signal line is read when the data is read from the bit.

(9)

The semiconductor storage device according to (8), further including

two selection transistors each individually connected to corresponding one of the two storage elements, in which

the selection transistors selectively switch presence and absence of an electrical connection between the first signal line and each of the two second signal lines via the connected storage elements.

(10)

The semiconductor storage device according to (8) or (9), in which

the control unit performs control so that one of the first signal line and each of the two second signal lines has a higher potential than a potential of the other in accordance with data to be written to the bit, and

when data is read from the bit, different data is read depending on whether the potential of the first signal line is higher or lower than an intermediate potential between respective potentials of the two second signal lines.

(11)

The semiconductor storage device according to (10), in which

the control unit

performs control so that, when first data is written to the bit, a potential of each of the two second signal lines is a reference potential and the potential of the first signal line is higher than the reference potential, and

performs control so that, when second data is written to the bit, the potential of the first signal line is the reference potential and the potential of each of the two second signal lines is higher than the reference potential, and

when data is read from the bit,

the first data is read in a case where the potential of the first signal line is higher than the intermediate potential, and

the second data is read in a case where the potential of the first signal line is lower than the intermediate potential.

(12)

The semiconductor storage device according to (10), in which

the control unit

performs control so that, when first data is written to the bit, the potential of the first signal line is a reference potential and a potential of each of the two second signal lines is higher than the reference potential, and

performs control so that, when second data is written to the bit, the potential of each of the two second signal lines is the reference potential and the potential of the first signal line is higher than the reference potential, and

when data is read from the bit,

the first data is read in a case where the potential of the first signal line is lower than the intermediate potential, and

the second data is read in a case where the potential of the first signal line is higher than the intermediate potential.

(13)

The semiconductor storage device according to any one of (10) to (12), in which the determination unit determines that the bit to which the two storage elements connected to the first signal line are assigned is abnormal in a case where the potential of the first signal line is substantially equal to the intermediate potential.

(14)

The semiconductor storage device according to any one of (1) to (13), in which the storage elements are magnetic tunnel coupling elements.

(15)

An electronic apparatus including a semiconductor storage device, in which

the semiconductor storage device includes

a plurality of storage elements each of which transitions to any of a plurality of states in accordance with an applied voltage,

a control unit that assigns, as one bit, at least two or more storage elements included in the plurality of storage elements and controls, for each bit, application of a voltage to each of the two or more storage elements corresponding to the bit, and

a determination unit that determines that the bit is normal in a case where a state of a part of the two or more storage elements assigned as the bit is different from a state of another storage element, and determines that the bit is abnormal in a case where respective states of the two or more storage elements are same.

### REFERENCE SIGNS LIST

| | |
|---|---|
| 100 | Semiconductor storage device |
| 101 | Storage element |
| 103 | Element array |
| 105 | Control circuit |
| 107 | Read circuit |
| 210 | Semiconductor storage device |
| M211 to M216 | MTJ element |
| T211 to T216 | Selection transistor |
| L211 to L217 | Signal line |

1. A semiconductor storage device comprising:
a plurality of storage elements each of which transitions to any of a plurality of states in accordance with an applied voltage;
a control unit that assigns, as one bit, at least two or more storage elements included in the plurality of storage elements and controls, for each bit, application of a voltage to each of the two or more storage elements corresponding to the bit; and
a determination unit that determines that the bit is normal in a case where a state of a part of the two or more storage elements assigned as the bit is different from a state of another storage element, and determines that the bit is abnormal in a case where respective states of the two or more storage elements are same.

2. The semiconductor storage device according to claim 1, wherein the control unit assigns, to the bit determined to be abnormal, other two or more storage elements different from the two or more storage elements assigned to the bit.

3. The semiconductor storage device according to claim 2, wherein the control unit assigns the two or more storage elements to the bit by associating a hardware address of each of the two or more storage elements with a software address set for each bit.

4. The semiconductor storage device according to claim 1, wherein the control unit performs control so that a state of a part of the two or more storage elements corresponding to the bit is a state different from another storage element when data is written to the bit.

5. The semiconductor storage device according to claim 1 wherein
the storage elements are storage elements that transition to states different from each other in accordance with a direction in which the voltage is applied, and
the control unit performs control so that the voltage is applied in directions different from each other to each of at least two storage elements of the two or more storage elements corresponding to the bit when data is written to the bit.

6. The semiconductor storage device according to claim 5, wherein
the control unit
performs control so that the at least two storage elements of the two or more storage elements corresponding to the bit are connected in parallel when data is written to the bit, and
performs control so that the at least two storage elements of the two or more storage elements corresponding to the bit are connected in series when data is read from the bit.

7. The semiconductor storage device according to claim 6, wherein
the control unit
assigns two storage elements included in the plurality of storage elements as the bit,
performs control so that the two storage elements corresponding to the bit are connected in parallel when data is written to the bit, and
performs control so that the two storage elements corresponding to the bit are connected in series when data is read from the bit.

8. The semiconductor storage device according to claim 7, wherein
the storage elements are storage elements whose states transition in a case where a voltage higher than a threshold value is applied,
the semiconductor storage device further comprises:
a first signal line commonly connected to the two storage elements; and
two second signal lines each individually connected to corresponding one of the two storage elements,
the control unit
controls a potential difference between the first signal line and each of the two second signal lines so that a first voltage higher than the threshold value is applied to each of the two storage elements when data is written to the bit, and
controls a potential difference between the two second signal lines so that a second voltage lower than the threshold value is applied to each of the two storage elements when data is read from the bit, and
data corresponding to a potential of the first signal line is read when the data is read from the bit.

9. The semiconductor storage device according to claim 8, further comprising
two selection transistors each individually connected to corresponding one of the two storage elements, wherein
the selection transistors selectively switch presence and absence of an electrical connection between the first signal line and each of the two second signal lines via the connected storage elements.

10. The semiconductor storage device according to claim 8, wherein
the control unit performs control so that one of the first signal line and each of the two second signal lines has a higher potential than a potential of the other in accordance with data to be written to the bit, and
when data is read from the bit, different data is read depending on whether the potential of the first signal line is higher or lower than an intermediate potential between respective potentials of the two second signal lines.

11. The semiconductor storage device according to claim 10, wherein
the control unit
performs control so that, when first data is written to the bit, a potential of each of the two second signal lines is a reference potential and the potential of the first signal line is higher than the reference potential, and
performs control so that, when second data is written to the bit, the potential of the first signal line is the reference potential and the potential of each of the two second signal lines is higher than the reference potential, and
when data is read from the bit,
the first data is read in a case where the potential of the first signal line is higher than the intermediate potential, and
the second data is read in a case where the potential of the first signal line is lower than the intermediate potential.

12. The semiconductor storage device according to claim 10, wherein
the control unit
performs control so that, when first data is written to the bit, the potential of the first signal line is a reference potential and a potential of each of the two second signal lines is higher than the reference potential, and
performs control so that, when second data is written to the bit, the potential of each of the two second signal lines is the reference potential and the potential of the first signal line is higher than the reference potential, and
when data is read from the bit,
the first data is read in a case where the potential of the first signal line is lower than the intermediate potential, and
the second data is read in a case where the potential of the first signal line is higher than the intermediate potential.

13. The semiconductor storage device according to claim 10, wherein the determination unit determines that the bit to which the two storage elements connected to the first signal line are assigned is abnormal in a case where the potential of the first signal line is substantially equal to the intermediate potential.

14. The semiconductor storage device according to claim 1, wherein the storage elements are magnetic tunnel coupling elements.

15. An electronic apparatus comprising a semiconductor storage device, wherein
the semiconductor storage device includes:
a plurality of storage elements each of which transitions to any of a plurality of states in accordance with an applied voltage;
a control unit that assigns, as one bit, at least two or more storage elements included in the plurality of storage elements and controls, for each bit, application of a voltage to each of the two or more storage elements corresponding to the bit; and
a determination unit that determines that the bit is normal in a case where a state of a part of the two or more storage elements assigned as the bit is different from a state of another storage element, and determines that the bit is abnormal in a case where respective states of the two or more storage elements are same.
